(19) United States
(12) Patent Application Publication
(10) Pub. No.: US 2009/0249492 A1
(43) Pub. Date: Oct. 1, 2009

(54) Fabrication of computer executable program files from source code

(76) Inventor: Hans Martin Boesgaard Sorensen, Lyngby (DK)

Correspondence Address: HARNESS, DICKEY & PIERCE, P.L.C., P.O. BOX 8910, RESTON, VA, 20195, US

(21) Appl. No.: 12/311,181

(22) PCT Filed: Sep. 21, 2007
(86) PCT No.: PCT/EP2007/060056

§ 371 Date: Apr. 24, 2009

Related U.S. Application Data
(60) Provisional application No. 60/874,955, filed on Dec. 15, 2006.
(60) Provisional application No. 60/907,465, filed on Apr. 3, 2007.

(30) Foreign Application Priority Data
Sep. 21, 2006 (DK) PA 2006 01221
Aug. 30, 2007 (DK) PA 2007 01237

(51) Int. Cl. G06F 9/45; G06F 21/00; H04L 9/06

(52) U.S. Cl. 726/27; 717/146; 380/44; 717/136

(57) ABSTRACT

A method for protecting a computer program against manipulation and for shielding its communication with other programs against eavesdropping and modification is presented. The method comprises the creation of individualized program copies to different groups of users, the insertion of or the derivation of individual cryptographic keys from the program code, the obfuscation of the program code, and the self-authentication of the program towards other programs. The method is suitable for the protection of online banking, online investment, online entertainment, digital rights management, and other electronic commerce applications.

### FIELD OF THE INVENTION

The present invention is generally concerned with securing computer programs, network communication, and stored data against attacks.

### BACKGROUND OF THE INVENTION

The increase in electronic commerce in recent years has also led to a rapid growth in computer crime. In particular, authenticating transactions over computer networks proved to be a major target of attacks, using a variety of techniques such as phishing. As an example, at the time of this writing, almost all major banks worldwide are under attack by various forms of identity theft, and while the financial losses are significant, the more important danger is that of bank users losing confidence in online banking.

It has become clear that the old recipes for protecting client-server connections over insecure networks (as e.g. user passwords or their combination with one-time passwords) no longer provide the necessary level of security. Attackers use a combination of more and more advanced techniques, such as man-in-the-middle attacks, phishing, DNS spoofing, and malware (viruses, Trojan horses). In this context, new protection techniques are required to secure financial online transactions.

The present invention can prevent most man-in-the-middle, phishing, and malware attacks on for example online banking applications, online investment applications, and online entertainment applications.

### SUMMARY OF THE INVENTION

### Nomenclature

Some of the terms used in this document are described in the following:
Argument: An input, e.g. to a function, a server, or a HTTP request
Asymmetric key: A cryptographic key to be used in an asymmetric algorithm.
Asymmetric algorithm: An algorithm using one key for encryption and another key for decryption or an algorithm using one key for signing and another key for verifying the signature, Can for example be RSA or ECC.
Authentication tag: See tag.
Block cipher: An encryption/decryption algorithm operating on plaintext/ciphertext blocks of fixed length. Can for example be AES or 3DES. Also see [Sc96] pp. 4 and 189-211.
Cipher: See encryption/decryption algorithm.
Ciphertext: An encrypted string.
Client application: A computer program that can connect to a server application. An application being a client towards a server might also be a server towards another client.
Composition: In this text, the composition of a function or algorithm that is different for each copy denotes the functionality of the specific function or algorithm in a specific copy. For example, one composition can be f(x)=3x+4 and another composition can be f(x)=7x−2.
Computer-executable program file: For example an .exe, .dll, .ocx, .class, or .jar file.
Copy: Two different copies of a computer program have the same overall features but may have different internal functions, e.g. key generators.
Cryptographic algorithm/function: In this text, this denotes a mathematical function (or its implementation) that is used for communication or storage in the presence of an adversary. Examples include encryption/decryption algorithms, message authentication codes (MAC), or hash functions.
Digital document: Includes HTML, XHTML, XML, PDF, word process files, and spread sheet files.
Encryption/decryption algorithm: An encryption algorithm encodes data under a key such that it cannot be distinguished from random data. A decryption algorithm reverses the encryption algorithm and restores the original data, using a key. Can e.g. be a block cipher, a stream cipher or an asymmetric cipher. Also see [Sc96] pp. 1-5.
Hash function: A function that takes a string of any length as input and returns a string of fixed length as output. The function achieves a strong mixing of the string, and its output can be used as a short identifier for the input. Examples are collision resistant hash functions, one-way functions, or any family of pseudo-random functions). Also see [Sc96] pp. 30-31.
IV: Initialization vector. A publicly known string that is used to avoid that a cryptographic algorithm always produces the same output.
Key: A string usually known only by some parties. Keys are used as input to cryptographic algorithms. Also see [Sc96] p. 3.
MAC function: A message authentication code (or MAC) takes a key and a data string as input and produces an authentication tag as output. If the key is a secret shared by sender and receiver and if the tag is appended to the message, the receiver can re-run the MAC to verify that the data has not modified since it was written. Also see [Sc96] p. 31.
One-time password (OTP) or one-time key (OTK): A key or password used only once, e.g. for authenticating a user.
Plaintext: An un-encrypted string.
PRNG: A pseudo-random number generator (or PRNG) takes a seed as input and generates an output string of arbitrary length. If the key is not known, the output string cannot be distinguished from random. Also see “pseudorandom sequence generator” in [Sc96] pp. 44-45.
Seed: Input to a PRNG.
Server application: A computer program that can receive connections from a client application and/or provide services to a client application.
Server: Software (i.e. server application), hardware, or combination thereof that can receive connections from a client application and/or provide services to a client application.
Source code: For example the content of a .java, .c, .cpp, .h, or .pas file.
Stream cipher: An encryption/decryption algorithm operating on streams of plaintext or ciphertext. Also see [Sc96] pp. 4, 189, and 197-199.
String: A block of data. Can be a text string (a set of characters) or a binary string (a set of bits).
Symmetric key: A cryptographic key to be used in a symmetric algorithm.
Symmetric algorithm: An algorithm using the same key for both encryption and decryption or for both creating an authentication tag and verifying an authentication tag. Can for example be a block cipher, a stream cipher, or a MAC function,
Tag: Output of a MAC function.
Time stamp: A string containing information about date and/or time of day.
Version: Two different versions of a computer program have different features. Usually, a new version has more or better features than the previous version.
XOR: Binary operation often denoted by 0.0 0=0, 0 1=1, 1 0=1, and 1 1=0.
[Sc96]: Bruce Schneier, Applied Cryptography, John Wiley & Sons, 1996.

### Introduction

In a first aspect, the invention provides a method of fabricating computer-executable program files from a source code, the method comprising the step of embedding, in each of the fabricated computer-executable program files, at least one value or means for generating at least one value, said value being uniquely selected or generated for each of the fabricated computer-executable program files, whereby all of the fabricated computer-executable program files are capable of carrying out instructions defined by the source code, and whereby each individual computer-executable program file is capable of generating a unique output, which depends on said uniquely selected or uniquely generated value.

It will hence be appreciated that the method of the first aspect of the present invention fabricates unique copies of a computer program (computer-executable program file), i.e. copies that are all capable of carrying out the same instructions to perform identical operations in terms of overall functionality. However, the copies fabricated by the method of the first aspect of the invention all differ from each other in that each copy is capable of generating a unique output.

It will be understood that, in embodiments of the method according to the present invention, the at least one value may be embedded as a static value. Alternatively, the at least one value may be generatable by the means for generating the value. The means for generating the value may be generated at the stage of fabricating the computer-executable program files. The means for generating the value are preferably adapted to generate the value at runtime of the computer-executable program files.

The unique output is normally generated at runtime of the computer-executable program files, but may also be embedded as a static value, which is generated at the fabrication stage.

In preferred embodiments of the invention, the means for generating the at least one value may comprise computer program functionality, such as source code, e.g. in macro or script language, or compiled code capable of generating the value.

The unique output is preferably reproducible by another program or accessible by another program. For example, different copies of the computer-executable program files fabricated by the present method may be distributed to different users, such as users in a computer network, such as online banking users. The other program capable of reproducing or accessing the unique output may, for example, be running on a server in the computer network, such as a server run by a bank. Hence, the unique output may be used as a common secret or used to generate a common secret, such as one or more encryption keys.

Whereas it has hitherto been a paradigm in the art of computer programming that all copies of a program were identical in al respects, the present invention relies on the fundamental principle that all copies are deliberately made non-identical. This brings about the advantage that it is rendered impossible to design a hacking tool capable of generally attacking the computer-executable program files fabricated by the present invention. For example, if an encryption key is hacked, this key is of no use if applied in a copy of the program different from the original unique copy of the program.

Preferably, the unique outputs of two copies of the computer program are uncorrelated, i.e. with the knowledge of one output, one cannot predict the unique output provided by another copy of the computer program.

For example, the computer-executable program files fabricated may be capable of carrying out online banking transactions. Hence, all copies of the program files will appear identical to users, i.e. all user interfaces are identical, and the programs carry out identical operations, except with regard to the unique output, which is different between different copies of the program files. The operations carried out by all copies of the computer program may e.g. include prompting for user id and password, offering various functionalities, such as money transactions, account inquiries, etc.

In most envisaged embodiments of the invention, the unique output produced by each individual copy of the program files is preferably not visible to or accessible by users. Such embodiments include, in particular, most online banking applications, media players, anti virus programs, other security programs, financial programs, games, distributed computing applications, DRM applications. However, the unique output may for certain applications be made visible to or accessible by users. For example, the output may be made available to users for debugging purposes.

The method according to the first aspect of the invention is preferably carried out on a device capable of automatically carrying out instructions as provided in a program. Preferably, the method is implemented on an electronic device including an electronic processor, such as a computer including a CPU.

From the above description, it will be appreciated that each user or group of users preferably uses (is provided with) a different copy of the computer-executable program file. Whereas for certain applications it may be acceptable that the same copy is provided to two different users among many users, it is usually preferred that a copy provided to a user is not re-used, i.e. is not provided to another user.

The embedded means for generating the at least one value may depend on at least one embedded value. The means for generating the at least one value may, for example, include a key generator for generating an encryption key, which is unique in respect of a particular copy of the program. The key generated by the key generator may depend from a value, which is specific for one single copy of the program file, and which has been embedded at the fabrication stage. In preferred embodiments, key generators of different copies of the program use different arithmetic functions as well as different embedded values to enhance security.

The process of fabricating computer-executable program files from a source code may be divided into at least two steps. In a first step, which is performed once, source code is converted into at least one intermediate file, such as a machine-code or object file. In a second, subsequent step, the at least one intermediate file and optionally other files are converted into the computer-executable program file. The second step is performed for each computer-executable program file. Thereby, fabrication is facilitated, as the first fabrication step, which is common to all copies, is only performed once.

At least a part of the source code used as input to the fabrication process may be evaluated to determine if it meets one or more predefined criteria for being equipped with the at least one embedded value or means for generating the at least one value. For example, at the step of fabricating, it may be determined if the computer-executable program file(s) to be used as input is intended to be capable of exposing confidential data. If this is the case, the fabrication software may be setup to deny fabrication.

The embedded means for generating the at least one unique value may comprise at least one extractor subfunction, as described in further detail below. The extractor subfunction(s) may be uniquely selected for each computer-executable program file.

As discussed, the unique output may be used to generate a cryptographic key, or used itself as a cryptographic key. Such key may e.g. be used to generate an authentication tag for authenticating data or for authenticating the program itself or other programs, or for authenticating the execution environment, in which the program is run. The execution environment to be authenticated may e.g. include an operating system, internet browser, or external software components.

The at least one embedded value or means for generating at least one value may be used as a serial number or to derive a serial number that can be used, e.g. by server software, to identify the copy of the computer program. For example, the server may include a database, from which the internal structure of the specific copy of the program can be derived, e.g. to reconstruct a key generator. In other words, information about how a computer-executable program file is generated can be stored, such that the computer-executable program file can be reproduced or its functionality or part thereof can be reproduced or simulated, for example by a server.

The at least one embedded value or the means for generating the value may be constructed by an algorithm using a pseudo-random number generator (PRNG). Hence, the fabrication method may include the following steps:
1. choosing a PRNG seed,
2. generating a string of pseudo-random bits from the PRNG seed using a pseudo-random number generator,
3. using the string of pseudo-random bits to determine at least one embedded value or how to construct the embedded means for generating at least one value.

Hence, if the PRNG seeds and the serial numbers of the individual copies of the program are stored, the embedded value or means for generating the value, e.g. a key generator, may be reproduced at a later stage, e.g. by a server.

To enhance security, the computer-executable program files may be obfuscated. More specifically, obfuscation renders it more difficult to extract, for example, a key generator from the fabricated program files, and patching of the fabricated program files is also rendered difficult.

The obfuscation method may depend random or pseudo-random data, so that its output varies in accordance with that data. Hence the obfuscation output may vary to further enhance security. Thus, if the obfuscation method is applied more than once to the same input (such as e.g. a source code or a compiled version of a program), the two obfuscated outputs will not be identical.

At least a part of the computer-executable program file may be stored in encrypted form and may be decrypted at runtime. For example, an unecrypted part of the program file may be used to initiate operation or setup of the program, e.g. to contact a server with a request for a decryption key for decrypting the remaining part(s) of the program file. The decryption key provided by the server may be provided in encrypted form and may be decrypted by the program file, using a cryptographic key derived from the unique output.

The fabricated computer-executable program file including the at least one embedded value or embedded means for generating at least one value may contain program code that can read profile data, such as:
brand, type, version, or serial number of a hardware component,
brand, type, version, or serial number of a software component,
software or hardware configuration data,
network configuration data, and
identity of the user
   where the profile data is used as input to the means for generating at least one value. It may thereby be ensured that the program is not executable on any other system (or in any other environment) than the one, at which it is intend to run. Alternatively, the program may include functionality allowing the profile data to be submitted to a server to allow the server to determine if the program is executed in an allowable environment.

As described further below in connection with FIG. 14, data may be sent in encrypted or authenticated form between a first and a second program (programs C and D in FIG. 14). The encryption/decryption key or authentication key may be derived from the at least one embedded value or means for generating the at least one value in the first program program C. The encryption/decryption key or authentication key may be derived in the second program D from knowledge about the at least one embedded value or means for generating at least one value in the first program C.

As described further below in connection with FIG. 15, data may be sent in encrypted or authenticated form between third and fourth programs, G and H in FIG. 15. The programs G and H both communicate securely with server I using cryptographic keys derived from G's and H's at least one embedded value or means for generating the at least one value. The server/provides at least one cryptographic key to G and H to be used to encrypt/decrypt or authenticate at least a part of the data sent between G and H.

The present invention further provides a server from which computer-executable program files fabricated according to the fabrication method described above can be downloaded. Further, the invention provides a server communicating with a computer-executable program file fabricated according to the present fabrication method.

The invention further provides a document into which at least one computer-executable program file fabricated according to the present invention is embedded. Further, the invention provides a computer on which at least one computer-executable program file fabricated according to the present invention is stored or executed. Further, the invention provides a computer program for fabricating computer-executable program files from source code, the computer program comprising means for performing the fabrication method according to the present invention. Further, the invention provides a computer-readable data medium comprising such a computer program, and a computer loaded with the computer program. Further, the invention provides a computer-executable program file fabricated by the fabrication method of the present invention.

Still further, the present invention provides a computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

The computer program may include functionality, i.e. program code, to carry out all method steps described above in connection with the fabrication method of the first aspect of the invention.

The present invention further provides a computer network comprising a server and a plurality of clients, wherein each client is loaded with a copy of a first computer program, and wherein the server is loaded with a second computer program, each copy of the first computer program comprising:
a computer-executable program file fabricated from a source code, which is common to all copies of the first computer program;
at least one embedded value or means for generating at least one value, said value or said means being included in said computer-executable program file, said value being uniquely selected or uniquely generated for the computer-executable program file, whereby the computer-executable program file is capable of carrying out instructions provided by the common source code and of generating a unique output, which depends from said uniquely selected or uniquely generated value; the computer network being programmed to communicate said unique output from each of the clients to the server, so as to enable the second computer program to authenticate each copy of the first computer program based on said output.

Each copy of the first computer program may include functionality, i.e. program code, to carry out all method steps described above in connection with the fabrication method of the first aspect of the invention.

The invention also provides a server for use in the above-described computer network, the server being suited for communication with said plurality of clients via the computer network, said second computer program being adapted to authenticate each copy of said first computer program based on said unique output.

The invention further provides a server communicating with a client computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

The computer-executable program file may include functionality, i.e. program code, to carry out all method steps described above in connection with the fabrication method of the first aspect of the invention.

The server may include functionality that allows it to recreate at least one of
at least one of the at least one embedded values, and
at least a part of the embedded means for generating at least one value as is embedded in a client program.

The server may further include functionality allowing it to load, from a database or file, at least one of
at least one of the at least one embedded values, and
at least a part of the embedded means for generating at least one value as is embedded in a Client Program.

Using a online banking application as example, FIG. 1 shows an attack scenario. In the top, we have the bank, which is considered secure. Below that, we have the Internet which connects the users' computers to the bank. From left, we have three legal users, who want to use the online banking application to conduct transactions. But at the right, we have an attacker who wants to make money by modifying other users' transactions or by fabricating transactions that to the bank look like transactions authorized by other users.

FIG. 2 shows the components involved in online banking. The user and the bank are considered secure, but the online banking program, the computer, the data stored on the user's computer by the online banking program, and the Internet can be under control of an attacker. This can be used by the attacker to trick the user and/or the bank to modify or make transactions in the attackers favor.

FIG. 3 shows how the present invention can improve the security of online banking. By inserting a key generator in the online banking program (“netbank program” in the figure), the online banking program's authenticity can be verified by the banking. Thus, the online banking program will be secure. Using this key generator, a secure link can be established to the banking (illustrated by the green arrow between the online banking program and the bank), and finally, online banking data stored on the user's computer can be protected (illustrated by the green arrow between the online banking program and the online banking data (“netbank data” in the figure). This solution leaves only one weakness: the link between the user and the online bank program (i.e. the user interface).

### Key Generator

In one embodiment of the present invention, a key extractor is embedded into a computer-executable program file. This key extractor may take an extractor IV as input and generates an extracted key as output (see left part of FIG. 4). The extracted keys can for example be used as key in cryptographic functions.

In one embodiment of the present invention, computer-executable program files are generated in a way such that one or more unique strings are embedded into each copy. These one or more unique strings can for example be used as parameters to a key extractor in order to generate keys that are unique for each copy, as serial numbers, or as keys in cryptographic functions.

In one embodiment of the present invention, the extractor function always returns a constant string. Thus, the extracted key is a constant.

In one embodiment of the present invention, the extractor function is build as shown in FIG. 5:
The function has a number of inner state words (their initial values are W₁, W₂, W₃, and W₄ in the figure).
A number of extractor subfunctions (F₁, F₂, . . . Fₙ in the figure) are manipulating the inner state words.
The resulting inner state words are manipulated (the L function in the figure) in order to generate the extracted key.

Each extractor subfunctions can take one or more inner state words as input and can change the value of one or more inner state words. One or more of the initial values of the inner state words (W₁, W₂, W₃, and W₄ in the figure) may be derived from an extractor IV. There can be one or more inner state words. One or more of the extractor subfunctions may depend on an extractor IV or value derived thereof. One or more of the extractor subfunctions may depend on a constant value.

In one embodiment of the present invention, extractor subfunctions are chosen from a set of available extractor subfunctions when the computer-executable program file containing an extractor function is generated. The set of available extractor subfunctions can be defined in the program generating the computer-executable program files containing an extractor function.

The function combining the inner state words into the extracted key (the L function in FIG. 5) can for example consist of one or more of:
A concatenation of the inner state words.
A hash function
A MAC function
An encryption function; e.g. one block cipher operation for each state words using the state word as key, forwarding the output (ciphertext) to the next as input (plaintext). The output of the last operation is the extracted key.

In one embodiment of the present invention, the extractor function is build as shown in FIG. 6:
Initial values of the inner state words are generated from the extractor IV by a function (the J function in the figure).
A number of extractor subfunctions are manipulating the inner state words (F₁, F₂, . . . Fₙ in the figure).
Parameters for the extractor subfunctions are generated from the extractor IV by a function (illustrated by the K function in the figure).
Constants for the extractor subfunctions (C₁, C₂, . . . Cₙ in the figure) are embedded in the computer-executable program file.
The resulting inner state words are processed by a function to generate the extracted key (the L function in the figure).

Each extractor subfunction can take one or more inner state words as input and can change the value of one or more inner state words.

In one embodiment of the present invention, the extractor subfunctions produces a balanced output, are non-linear, and/or are correlation-resistant.

In one embodiment of the present invention, the extractor subfunctions relies on bijective function (e.g. addition, subtraction, xor, or rotating) or on table lookups (e.g. the s-boxes from the encryption algorithm AES).

In one embodiment of the present invention, extractor functions have jump instructions. These jump instructions may for example be conditional. The conditional jumps can for example depend on one or more of:
One or more inner state words.
The extractor IV.
A constant value.

In one embodiment of the present invention, an extracted key or one or more unique strings are used as input to a blender function (see right part of FIG. 4). This blender function also takes a blender IV as input and generates a purpose key as output.

In one embodiment of the present invention, the output from a key generator (an extracted key) is used as input to a blender function (see FIG. 4).

In one embodiment of the present invention, a unique key generator function is embedded into each computer-executable program file. The extractor function is or is not different for each copy. The blender function is or is not different for each copy.

In one embodiment of the present invention, a blender function relies on cryptographic functions to generate the purpose key from its inputs.

In one embodiment of the present invention, a blender function concatenates the blender IV and the extracted key and processes the resulting string (or a string derived thereof) by a hash function. The output from the hash function or a string derived thereof is used as purpose key.

In one embodiment of the present invention, a blender function uses the blender IV (or a string derived thereof) as message and the extracted key (or a string derived thereof) as key to a MAC function. The output of the MAC function (or a string derived thereof) is used as purpose key.

In one embodiment of the present invention, a blender function uses the blender IV (or a string derived thereof) as plaintext and the extracted key (or a string derived thereof) as key to a block cipher. The output of the block cipher (or a string derived thereof) is used as purpose key.

In one embodiment of the present invention, a blender function uses the blender IV (or a string derived thereof) as key and the extracted key (or a string derived thereof) as plaintext to a block cipher. The output of the block cipher (or a string derived thereof) is used as purpose key.

In one embodiment of the present invention, the key generator consists of a constant string that directly or after manipulation is used as key for a block cipher. The generator IV (or a string derived thereof) is used as plaintext and the cipher text output (or a string derived from it) is used purpose key.

In one embodiment of the present invention, the key generator consists of a constant string that is concatenated with the generator IV or by other means combined with the generator IV. The resulting string is hashed and the resulting string (or something derived from it) is used as purpose key.

In one embodiment of the present invention, an extractor IV and/or a blender IV are derived from a key generator IV.

In one embodiment of the present invention, a key generator IV is derived from a counter value.

In one embodiment of the present invention, a key generator IV is derived from a time stamp.

In one embodiment of the present invention, several purpose keys are generated from one key generator IV. This can be achieved in several ways, for example:
By manipulating the key generator IV before calling the key generator.
By manipulating the extractor IV.
By manipulating the blender IV.
By manipulating the extracted key, e.g. appending a string to it.
By manipulating the purpose key returned by the key generator.
By manipulating the purpose key returned by the key generator and sending the manipulated key through a cryptographic function, e.g. a hash function.
By using different key generator functions (completely different or with just one or more components different).

In one embodiment of the present invention, a purpose key is used as at least one of:
An encryption key.
A decryption key.
An authentication key.
An authentication value (i.e. a value that can be used to confirm that a computer-executable program file contains a given key generator).

In one embodiment of the present invention, data from the user, data about the user, or data from something in the user's possession is included in the key generation process. In this way, user authentication can be embedded into the key generation. Data from the user can for example be a password, an account number, or a user name. Data about the user can for example be biometric data. Data from something in the user's possession can for example be a one-time password or a short-time password (e.g. from a password generator device) or a key stored in a file on a devices (e.g. a hard disk or a USB memory stick).

In one embodiment of the present invention, a computer-executable program file has several key generators.

In one embodiment of the present invention, one computer program has a key generator embedded into its program code. Another computer program has knowledge about the composition of the key generator and can, based on this knowledge, reproduce the key generator's functionality and thus its output.

In one embodiment of the present invention, the process of generating a computer-executable program file with a key generator comprises generating a random or unique seed string. This seed string is expanded to a longer string using a PRNG. This string (or something derived from it) is divided into substrings used for constructing the extractor function. These substrings can for example choose which extractor subfunctions to use, on which inner state words they operate, or be used as constants given to the subfunctions (e.g. C₁, C₂, . . . Cₙ in FIG. 6). If all non-static information needed to construct an extractor function is derived from the expanded string (and thus from the seed string), knowledge of the seed string is enough to reproduce the complete key generator.

In one embodiment of the present invention, computer-executable program files with unique key generators are given unique serial numbers. This serial number can for example be used to look up the copy's PRNG seed in a table or a database. If a party knows the PRNG seeds used to generate a program with a given serial number, that party can reproduce the key generator and thus produce the same keys as the computer-executable program file. The serial numbers can for example be consecutive, random, or encrypted consecutive numbers.

In one embodiment of the present invention, a computer-executable program file with a key generator is embedded or included in another file, for example a java archive file (.jar file), an archive file (e.g. a .tar file), a compressed file (e.g. a .gz file), a compressed archive file (e.g. a .zip file), or an install file.

### Client and Server

In one embodiment of the present invention, a client program has a key generator embedded into its program code and a server has knowledge about the composition of the key generator. Thus, the client program and the server program can generate the same purpose key given the same key generator IV.

In one embodiment of the present invention, client programs with embedded key generators are communicating with one or more server programs. FIG. 7 shows an example. The client program generator is a program that can generate client programs with unique embedded key generators. For each client program it has generated, it stores the generated program in a program file database and the program's serial number and PRNG seed in a seed database. The client program can for example be distributed to users via a web server or on optical media via retail stores or by mail. When the user uses the client program, the client program can communicate with a transaction server using purpose keys generated by the key generator if the transaction server has access to the seed database, since it using the program's serial number (sent from the client program to the server) can find the client program's seed in the seed database and using the seed can reproduce the client program's key generator.

In one embodiment of the present invention, client programs with embedded key generators are communicating with one or more server programs. The client program generator stores the generated client programs in a program file database and stores the program's serial number with a program containing only the key generator as embedded in the generated client program in a key generator database. When the user uses the client program, the client program can communicate with a transaction server using keys generated by the key generator if the transaction server has access to the key generator database, since the key generator program can generate the same keys as the client program's key generator.

In one embodiment of the present invention, client programs with embedded key generators are communicating with one or more server programs. The client program generator generates client programs with unique key generators on-demand when a user requests a program. When a client program is generated, the serial number and PRNG seed is stored in a seed database. Alternatively, serial number and key generator is stored in a key generator database.

In one embodiment of the present invention, HTTP caching e.g. by proxy servers is prevented by giving unique names to each computer-executable program file, e.g. by adding a argument string (e.g. “?rand_id=0x5E9A005F”) to the file name URL, where the hexadecimal number is unique for each user (e.g. stored on user PC in cookie) or unique in general.

### Obfuscation

In one embodiment of the present invention, the generated computer-executable program file or a part thereof is obfuscated. This obfuscation may make it harder to derive information on how the key generator function is build and/or to make it harder to reverse-engineer the program in general. Furthermore, the obfuscation may make it harder to produce a computer program that can automatically patch (i.e. modify) the computer-executable program file.

The obfuscation process can for example comprise one or more of the following techniques:
Replacing a program instruction or a set of program instructions with another program instruction or set of program instructions with equivalent functionality.
Reallocate registers, i.e. change the use of processor or co-processor registers.
Change the order of the program instructions.
Change the order of functions or program instruction blocks.
Change loop structure, e.g. inline functions, add meaningless jumps, or replace loop with post-evaluation of condition with loop with pre-evaluation of condition.
Inserting useless data or program instructions.
Interleaving one or more program sequences.
Reordering of static data.
Reordering of runtime data.
Encryption of program instructions.
Encryption of static data.
Replace constant values with code generating the constant values.
Move static or runtime data between stack, heap, and registers.
Use several stacks.
Use several stack pointers to the same stack.
Make the program code self-modifying.
Mix data with program code.
Rename classes, functions, or variables. (e.g. exported function and variables)
Rename files or modules.

In one embodiment of the present invention, byte code (e.g. Java code) can be obfuscated by removing the structure of the compiled byte code. After normal compilation, source code files (e.g. .java files) are compiled into output files (e.g. .class files). The output files contain information about the program code's interface etc. A group of output files is often combined in an archive file (e.g. a .jar file). These output files are linked together at runtime. The problem is that all this structure of the compiled code makes the code easier to analyze and reverse-engineer. This structure can, however, be removed by restructuring the code in a way such that functionality from a number of output files is combined into one output file. This may require that the program code can handle some tasks that are normally handled by the system, e.g. assigning and freeing memory, handling stack, and handling error situations.

In one embodiment of the present invention, byte code representing more than one class or more than one function is combined into byte code representing one class or one function. FIG. 13 illustrates an example. On the left side, the function A contains program code (the lines with aa, bb, cc, and dd). A also contains a call to the function B and a return statement that returns from the function A. The function B also contains program code (the lines with ee, ff, gg, and hh), a call to the function C, and a return statement. The function C contains program code (the line with ii) and a return statement. On the right side of the figure, the functions A and B are combined. The combined function is called A and still has all the functionality of the original function A but has the functionality of the function B embedded into it. The beginning of the new function A is similar to the original function A except that the call to B is now a local jsr (jump to subroutine) The code from the original function B is inserted hereafter, but before the original B code, functionality to allocate temporary memory to be used by the functionality of B is added (in the original code this was handled automatically by the runtime environment or operating system as B was a separate function). Similarly, functionality to free temporary memory is added in the end of the original B code. Also, the “return from function” statement is replaced by a local ret (return from subroutine) statement. The call to C is unchanged. Also the function C itself is unchanged.

In one embodiment of the present invention, obfuscation methods are used that confuse debugging tools or disassembler/decompiler tools, e.g. adding program code between functions that is never called but confuses a disassembler to decode the code with wrong alignment or use of software interrupts.

Table with Program Parameters

In one embodiment of the present invention, destination addresses for jump instructions and/or parameters to instructions are read from a table. The table or part thereof might be provided in the computer-executable program file, eventually in encrypted form to be decrypted at runtime. The decryption key used to decrypt the encrypted table entries might be generated by a key generator, read from a file or downloaded from a server. The table or part thereof might be downloaded or updated with records downloaded from a server.

In one embodiment of the present invention, a table as described above is given to a client application to allow it to be executed as part of an anti-piracy scheme. This table can for example be given when the user has registered his copy and/or typed in his copy's serial number. This table can for example be stored on disk in encrypted form when is has been received by the client application.

### Check Program Before Fabrication

In one embodiment of the present invention, a source code file or an intermediate file derived from a source code file is evaluated before being processed in order to determine if it meets certain criteria before the source code converted into a computer-executed program file and is equipped with a key generator. These criteria might be defined by the same organization as developed the source code. A description of these criteria might be distributed along with the computer-executable program file.

In one embodiment of the present invention, the criteria used to evaluate a source code file or intermediate file are defines such that the evaluated program cannot export data, access data, create data, or manipulate data in a way not wanted by the entity defining the criteria. A criteria file can be a manifest file as e.g. used in Java.

In one embodiment of the present invention, a criteria file associated to a computer-executable program file is evaluated before the computer program is executed to determine if the criteria meets the policies defined for the computer or environment it is about to be executed on.

### Hardware Binding

In one embodiment of the present invention, a computer program collects data that can be used to identify the computer it runs on (also called hardware profile data). This data can for example be any of:
Brand, type, version, or serial number of hardware components.
Brand, type, version, or serial number of operating system.
Brand, type, version, or serial number of hardware drivers.
Brand, type, version, or serial number of software components.
Software configuration data.
Hardware configuration data.
Identity (e.g. user name or e-mail address) of the user.
MAC number, IP number, DNS settings, or other network configuration data.

In one embodiment of the present invention, a server application collects data about the computer a client application runs on without involving the client application. This data can for example be any of:
IP number.
Brand, type, or version of browser.
Operating system details.

In one embodiment of the present invention, a server application uses hardware profile data (collected by client program and/or server program) to detect if a client program runs on the correct computer.

In one embodiment of the present invention, hardware profile data collected by a client application is combined in groups of strings. These strings are hashed, and the resulting strings are sent to the server. This can anonymize the user's data but still allow the server application to detect changes in the hardware profile. A string unique for the given user or client application can for example be added to the hardware profile data strings before hashing. This will ensure that even if two users have the same hardware components, the server cannot detect it as the hash strings will be different.

### Program Authentication

In one embodiment of the present invention, the generated computer-executable program file can be authenticated to detect if it is authentic. This authentication can for example be performed by the program itself, by another program, or by a hardware device. This authentication can for example be based on a purpose key generated by a key generator.

FIG. 8 shows a method for authenticating a computer-executable program file. A purpose key is generated by the key generator (KG in the figure) from a key generator IV. The program file may be pre-processed by a function (F in the figure). The program file or the pre-processed program file is then processed by a MAC function taking the generated purpose key as its key. The output of the MAC function is the authentication tag used to authenticate the program. The pre-processor might be individual for each program copy.

In one embodiment of the present invention, a method for authenticating the computer-executable program file is to process the file, a part thereof, or something derived thereof by a hash function to obtain a hash value representing the content of the file. Another method is to process several parts of the computer-executable program file or something derived thereof to obtain several hash values as illustrated in FIG. 9. These parts may overlap and parts may be left out. This processing might be individual for each copy of the computer-executable program file. Instead of hash functions, other cryptographic functions, e.g. MAC functions can be used to obtain a value with similar properties as a hash value. The one or more hash values can for example be processed by a MAC function where the MAC function is given a purpose key from a key generator (KG in the figure) as key.

In one embodiment of the present invention, the authenticity of a computer-executable program file can be verified by calculating the expected MAC value and compare it with the MAC value generated by the program. If these are equal, the computer-executable program file is considered authentic. For example, a server might generate a random key generator IV value and send it to a client program. The client program then generates the MAC value over its own computer-executable program file using the key generator IV as input to the key generator. The generated MAC value is returned to the server. The server already knows the hash value(s), generates the MAC key, and calculates the MAC value. If the server's calculated MAC value is equal to the MAC value received from the client, the client is considered authentic.

In one embodiment of the present invention, a part of the computer-executable program file is not authenticated. This can for example allow for patching and updating without changing data on the server.

In one embodiment of the present invention, a part of a computer-executable program file is updated. The hash value(s) on the server for the parts of the file that is updated are updated to allow the server to verify the authenticity of the new computer-executable program file.

In one embodiment of the present invention, a computer-executable program consists of several files. All or some of these files are included in the authentication process.

In one embodiment of the present invention, a computer-executable program file authenticates itself towards another computer-executable program file. This allows for example sub-modules to authenticate themselves towards a main module.

In one embodiment of the present invention, a computer-executable program file is authenticated towards on or more of:
Another computer-executable program file (e.g. running on the same computer or on another computer).
A security-related hardware component (e.g. a Trusted Platform Module (TPM), a smartcard, or a smartcard reader).
An input-output device (e.g. a graphics adaptor, a screen, a keyboard, a keyboard adaptor, a mouse, a mouse adaptor, a sound card, a speaker, or a microphone).
A communication device (e.g. a network adaptor, a modem, a switch, a router, or a firewall)
A network (e.g. towards a switch, a router, or a firewall).
A storage device (e.g. a hard drive, a storage adaptor, a raid adaptor, a storage-area network (SAN), or a network-attached storage (NAS))
Another kind of hardware module.
A program running on another hardware device (e.g. another computer or a server).

In one embodiment of the present invention, the generated authentication tag is used as a key. Different keys can for example be generated by appending different strings to the input to the MAC function.

In one embodiment of the present invention, an execution environment in which a computer-executable program file is executed is authenticated. This authentication can for example be performed by hashing some or all of the program code, computer-executable program files, and data files of the execution environment. The generated hash value can for example be compared with a list of known hash values of authentic or accepted execution environments stored in the program calculating the hash value or sent to a server that can compare it with a list of authentic or accepted hash values.

### Secure Communication Link

In one embodiment of the present invention, a purpose key generated by a key generator is used to encrypt data to be transmitted or to decrypt data that has been transmitted.

In one embodiment of the present invention, a purpose key generated by a key generator is used to generate an authentication tag on data to be transmitted or data that has been transmitted. This tag can for example be transmitted along with the data. The transmitted tag can for example be compared with the tag generated by the receiver to verify if the transmitted data is authentic.

In one embodiment of the present invention, a secure communication link is established between a server application and a client application by using the shared knowledge of the client's key generator.

An example of a procedure for establishing a secure communication link:
The client application connects to the server application.
The server generates one or more random key generator IVs and sends them to the client application.
Using the key generator IVs, one or more keys are generated by both the client application and the server application.
Using the one or more keys, data sent between the client application and the server application is encrypted and/or authenticated.

In one embodiment of the present invention, a program authenticity check is built into setting up the link encryption/authentication keys. For example, the key generator IV generated by the server is used to generate an authentication tag authenticating the computer-executable program file. This tag can for example be used as key or one or more keys can be derived from the tag. Keys can be derived for example by appending a string to the authentication tag and hashing it. This hash value is then used e.g. as encryption key. Append another string to the tag and hash it. This second hash value is used e.g. as authentication key. See FIG. 10. Another example is to use the authentication tag as key and encrypt one string using an encryption algorithm to obtain an encryption key and to encrypt another string to obtain an authentication key.

In one embodiment of the present invention, the key generator IV is generated from a string generated by the server application and a string generated by the client application. These two strings can for example be combined by means of a hash function.

In one embodiment of the present invention, individual messages are protected. An example:
The sending party generates a key generator IV.
Using the key generator IV, an encryption key and an authentication key are generated by a key generator.
The payload string is encrypted and authenticated using the keys.
The protected payload string and the key generator IV are sent to the recipient.
The recipient generates the two keys using the key generator IV.
The recipient verifies the authenticity and decrypts the payload string.

Two key generator IVs may be generated and used instead of one to generate the two keys.

In one embodiment of the present invention, request and response messages are protected. An example:
The requesting party generates a key generator IV.
Using the key generator IV, an encryption key and an authentication key are generated by a key generator.
The request payload string is encrypted and authenticated using the keys.
The protected request string and the key generator IV are sent to the responding party.
The responding party generates keys using the key generator IV.
The protected request string is verified and decrypted by the responding party.
The response payload string is encrypted and authenticated using the keys.
The protected response payload is sent to the requesting party.
The protected response payload is verified and decrypted by the requesting party.

For increased security, the requesting party and the responding party may use different IVs for encryption and authentication or use different keys, e.g. using a derived key generator IV for generating keys for protecting the response payload or using different generator IVs each way. The derived key generator IV may consist of the original key generator IV combined with a key generator IV chosen by the responding party. The responding party's key generator IV may be unique for each message and may be sent with the message to the requesting party. The combination can for example be achieved by XOR'ing the key generator IVs, by concatenating them and hashing the result, or by a block cipher by using the requesting party's key generator IV as plaintext and the responding party's key generator IV as key.

In one embodiment of the present invention, communication link sessions are protected. The communication link may be used to transmit data synchronous or asynchronous. An example:
The client application connects to the server application.
The server application generates a key generator IV and sends it to the client application.
Server and client generate encryption and authentication keys based on the key generator IV.
All sub-sequent messages are protected using these keys.

For increased security, different IVs or different keys could be used for encrypting and/or authenticating each message. The generator IV can for example be a combination of a string generated by the server and a string generated by the client. An example of an application using asynchronous transmission is AJAX (Asynchronous JAva XML).

For some applications, it might be relevant to use only encryption or only authentication. In that case, the above mentioned embodiment can for example be modified by omitting the unneeded key.

In one embodiment of the present invention, the server application and the client application are communicating by means of at least one of:
A TCP/IP socket.
A modem.
An xDSL connection.
A VPN connection.
A SSL or TLS connection.
A web browser (e.g. using HTTP or HTTPS), for example via
   Cookies.
   Arguments sent to server by GET or POST commands.
   Data embedded into HTML, XHTML, or XML.
   Data returned by GET or POST commands.
   HTTP headers.
E-mail.
Instant messaging applications.
Files.
SMS (e.g. on GSM phones).

In one embodiment of the present invention, the transmitted data protected is payment data. Payment data can for example comprise a credit card number, a password, or a one-time password.

### Communication Scenarios

In one embodiment of the present invention, two computer programs communicate with each other protected by cryptographic key(s) downloaded from a server. The communication with said server might be encrypted using a purpose key. The communication with said server might be authenticated using a purpose key. The downloaded might be symmetric or asymmetric.

In one embodiment of the present invention, a first client application communicated with a server protected by purpose keys. The first client application communicates with a second client application protected by purpose keys generated by the second client application's key generator. The first client application gets the keys needed to communicate with the second client application from a server knowing how the key generator of the second client application is constructed.

In one embodiment of the present invention, a program communicates with a second program; the two programs verifies if they run on the same computer by sending profile data or something derived thereof to each other.

### Inner Key Exchange

In one embodiment of the present invention, a secure communication channel is established between a client application and a server application. Through this channel, a key exchange protocol is executed to establish an exchanged set of keys. The key exchange protocol might be based on the Diffie-Hellman protocol. The exchanged set of keys might be used to encrypt and/or authenticate data sent between the client applications and the server application.

In one embodiment of the present invention, a secure channel is established between two computer programs; at least one of them has an embedded key generator. Through this channel, a key exchange protocol is executed to establish an exchanged set of keys. The key exchange protocol might be based on the Diffie-Hellman protocol. The exchanged set of keys might be used to encrypt and/or authenticate data sent between the client applications and the server application.

In one embodiment of the present invention, a secure communication channel is established between a server application and a client application. Through this channel, a public asymmetric key is sent. The party sending the public key has the corresponding private key. One party generates a cryptographic key and encrypts it using one of the asymmetric keys; the encrypted key is sent to the other party which decrypts it using the other asymmetric key. The algorithm used to perform the encryption/decryption might be RSA or ECC.

### Secure Storage

In one embodiment of the present invention, a purpose key generated by a key generator is used to encrypt data to be stored or to decrypt data that has been stored.

In one embodiment of the present invention, a purpose key generated by a key generator is used to generate an authentication tag on data to be stored or data that has been stored. A tag can for example be written along with the data. A read tag may be compared with the tag generated by the reader to verify if the stored data is authentic.

In one embodiment of the present invention, an encrypted file is created by the following procedure:
A random key generator IV is chosen.
The key generator IV is stored in the file.
Using a key generator, two purpose keys are generated; one key for encryption and one for authentication.
Payload is encrypted and authenticated using the generated keys and stored in the file.
The generated authentication tag is stored in the file.

The file can then be read using the following procedure:
Read the key generator IV.
Generate encryption key and authentication key.
Read encrypted payload from the file
Calculate an authentication tag over the encrypted payload using the authentication key. If the tag matches the tag read from the file, the content is authentic.
The payload is decrypted using the encryption key.

Encryption or authentication may be omitted if desired. Two key generator IV's may be used instead of one.

In one embodiment of the present invention, stored data is encrypted and/or authenticated with a key that depends on hardware profile data. This makes the files unreadable by a computer with another hardware profile than the one that wrote the file.

In one embodiment of the present invention, an encrypted file is created by the following procedure:
Two random key generator IVs are chosen.
The key generator IVs are is stored in the file.
Using a key generator, two purpose keys are generated.
A random encryption key and a random authentication key are chosen.
Using the two purpose keys, the two random keys are encrypted (e.g. using XOR or an encryption algorithm). The encrypted keys are stored in the file.
Payload is encrypted and authenticated using the random keys and stored in the file.
The generated authentication tag is stored in the file.

The file can then be read using the following procedure:
Read the key generator IVs.
Generate the two purpose keys using a key generator.
Decrypt the two read keys using the two generated purpose keys.
Authenticate and decrypt the payload using the two decrypted keys.

Encryption or authentication (and their keys) may be omitted if desired. One purpose key may be used instead of two (also if both encryption and authentication is used; both keys may be encrypted using the same key). One key generator IV may be used instead of two.

In one embodiment of the present invention, an encrypted file is created by the following procedure (also see FIG. 11):
A random key generator IV is chosen.
The key generator IV is stored in the file.
A random encryption keys is chosen.
A purpose key is generated by the key generator (KG in the figure) using the key generator IV.
A program authentication tag is created (by MAC in the figure) using the purpose key as MAC key.
Hardware profile data is read. The hardware profile data is collected in groups. For each group
   The authentication tag and the hardware parameter group data string are hashed (by upper H in the figure).
   The output from the hash function is XOR'ed with the encryption key (this way, the key is encrypted). The resulting string is stored in the file.
   The output from the hash function is hashed again (by lower H in the figure). This second-order hash string is stored in the file.
The payload is encrypted using the encryption key. The encrypted string is stored in the file.

The file can be decrypted using the following procedure:
Read the generator IV.
A purpose key is generated by the key generator using the key generator IV.
A program authentication tag is created using the purpose key as MAC key.
Hardware profile data is read. The hardware profile data is collected is the same groups as when encrypting the file. For each group:
   The authentication tag and the hardware parameter group data string are hashed.
   The output from the hash function is hashed again. The output is compared to the second-order hash strings in the file.
   If a matching second-order hash string is found in the file, the corresponding XOR'ed key is read. This key is XOR'ed with the original hash string (first-order hash string) to obtain the encryption key.
The encrypted payload is decrypted using the found encryption key.

If program integrity is not needed, the MAC function is removed and the purpose key is used directly as part of the input to the first (upper) hash function. If hardware binding is not needed, the output from the MAC function is used as encryption key; no hash strings or encrypted keys are stored in the file. Hardware parameter data may be manipulated prior to the first hashing. If just one hardware profile group is used, just use the output from the first hash function as key (no hash strings or keys are stored) or use it to encrypt the key (no hash strings are stored but the encrypted key is stored). If no key generator is present, the purpose key may be replaced by a constant or the MAC function used in generating the authentication tag may be replaced by a hash function or the authentication tag may be omitted as input to the first hash function (i.e. only hardware profile data is input). The key generator IV, second-order hash strings, and/or encrypted keys may be stored in the same file as the (encrypted) payload or in one or more other files. If the file is also to be authenticated, a second random key is chosen in the file generation step and two encrypted keys are stored instead of one for each second-order hash. The encrypted keys may be encrypted by other functions than xor; for example by an encryption algorithm. If more keys are generated for the same hardware profile, the input to the first hash function may be manipulated in different ways (e.g. by appending different strings) to obtain different hash strings for each key. Several encrypted keys for each second-order hash may be stored, allowing to decrypt (or verify authenticity of) several files or parts of files. Different files or parts of files encrypted using different keys may be decrypted by knowing different hardware profile data (e.g. more secret data may require more correct hardware parameters than less secret data).

In one embodiment of the present invention, a file encrypted by one copy of a client program can be re-encrypted to be accessible by another copy of a client program. For example, if the file is encrypted using a key generated by the first copy's key generator, the file can be sent to the server, the server (knowing how both the first copy's and the second copy's key generator's compositions) can generate the keys needed to decrypt the file and encrypt it again for the second copy. As another example, if the file's encryption key is encrypted using a key generated by the first copy's key generator, the encrypted key can be sent to the server, the server (knowing how both the first copy's and the second copy's key generator's compositions) can generate the keys needed to decrypt the key and encrypt it again for the second copy

In one embodiment of the present invention, a key generator is used to encrypt/decrypt and/or authenticate a cookie (e.g. used in a web browser or a web server).

### Version Update

In one embodiment of the present invention, a new version of a copy of a computer-executable program file is generated such that the new version has a key generator equivalent to the one of the old version.

In one embodiment of the present invention, an old version of a computer-executable program file downloads a new version with a key generator equivalent to the one of the old version.

In one embodiment of the present invention, an old version of a computer-executable program file in the form of an embedded object in a home page receives a message from a server application telling it to forward the browser to another page using an argument given by the server application. This other page combined with the given arguments allows the web server to send a new version of the computer-executable program file with a key generator equivalent to the one of the old version.

In one embodiment of the present invention, a database containing at least two of: user ID, client program serial numbers, client program version number, and client program PRNG seeds is maintained. When a new version of the client program is sent to a user, the database is updated accordingly.

In one embodiment of the present invention, a client program is updated if certain criteria are fulfilled. For example, when a client program connects to a server, the client program sends an identification string to the server (e.g. containing its serial number). If the server decides that the client program needs to be updated, it sends a message to the client program saying that it should update itself. If the client program is a program embedded into a homepage, the auto update may be initialized by forwarding the containing page to another URL, the other URL initiates the update.

Before a client program embedded into a home page is started, the browser (or another component on the client computer) will usually check if a newer version of the client program is available. The check is usually performed by contacting a server using HTTP or HTTPS. In one embodiment of the present invention, the server decides if a newer version should be downloaded to the user based on at least one of: the content of a cookie, arguments given to the referrer site (can be detected through the “referrer” header line), or the “last-modified” header line.

### Digital Rights Management

In one embodiment of the present invention, a key generator is used to generate keys to decrypt and/or verify the authenticity of digital content, for example video, music, computer programs, or computer games.

In one embodiment of the present invention, a playback device (e.g. a media player or a gaming console) has an embedded key generator. This key generator can for example generate keys that can decrypt and/or verify the authenticity of digital content or generate keys that can decrypt keys that can be used to decrypt and/or verify the authenticity of digital content.

In one embodiment of the present invention, a distributor of digital content encrypts or generates an authentication tag using a random key. This key is encrypted using a key generated by a server knowing how the user's application's key generator is constructed. The protected content and the encrypted key are sent to the user, who can play it using his client application. If the user also wants to play the content on another playback device, he can apply (e.g. the content owner) for the key encrypted for the other device.

In one embodiment of the present invention, digital content is protected and distributed as illustrated on FIG. 12. The user acquires a playback device (e.g. a media player) from a player vendor. This playback device has an embedded key generator. The player vendor informs a license manager about how the key generator is constructed such that the license manager can reproduce it. The content is stored by the content vendor. When a user wants to download (or in another way acquire) content, the content is encrypted and/or an authentication tag is generated (alternatively, this process can be performed ahead of the user's request). The content is sent to the user e.g. over the Internet (or another network, a satellite link, a radio link, or on a media, e.g. a DVD). The content can for be stored on the user's storage for later use or can be processed by the playback device right away. To use the content, the playback device acquires a key from the license manager (e.g. in encrypted form such that it can be decrypted using the playback device's key generator). This key can be stored for later use or can be used right away.

In one embodiment of the present invention, each copy or set of copies of a digital content is encrypted using a unique key. Optionally, a serial number, a product number, and/or another form of identification may be embedded into the encrypted content. When a user wants to use the content, he contacts a server and requests a key for that copy of that content (may be downloaded in encrypted form) to become able to decrypt the content.

In one embodiment of the present invention, all copies of a digital content are encrypted using the same key. Optionally, a product number and/or another form of identification may be embedded into the content. When a user wants to use the content, he contacts a server and requests a key for that content (may be downloaded in encrypted form) to become able to decrypt the content.

In one embodiment of the present invention, the playback device acquires keys (e.g. using the internet, a satellite link, or a radio link) for each playback of the content.

In one embodiment of the present invention, the playback device acquires keys that a stored and used for several playbacks of the content.

In one embodiment of the present invention, digital content is acquired; decrypted if it was acquired in encrypted form; and encrypted using a purpose key generated by a key generator.

### User and Transaction Authentication

In one embodiment of the present invention, a key generator is embedded into an authentication token (like e.g. RSA SecureID). This authentication token can for example generate one-time passwords used to authenticate a user.

In one embodiment of the present invention, a key generator is used to periodically generate new master keys in an authentication token.

In one embodiment of the present invention, the output of an authentication token is derived from a purpose key generated by a key generator.

### Authenticate Boot Image

In one embodiment of the present invention, a key generator is embedded into a device (e.g. a cell phone, a PDA, a gaming console, or a set top box), for example in the boot-strap code of the device. Using this key generator, data (e.g. program code or content) can be authenticated. For example, a boot image stored in flash memory can be verified by boot-strap code stored in read-only memory to verify is the boot image is authentic and intact. This can for example be achieved by appending a MAC tag to the boot image that can be verified using the key generator in the boot strap code. This MAC tag can be generated by a server that knows how the key generator in the specific device is constructed.

In one application of the present invention, a key generator is embedded into a device. Using this key generator, data can be decrypted or encrypted. For example, a boot image can be decrypted as part of the installation process, such that a user can download an encrypted boot image over the internet, this boot image can only be decrypted by a device having a given key generator.

In one embodiment of the present invention, a key generator embedded into a device is used to generate keys to secure a network link, secure stored data, or access digital content.

### Hardware Key Generators

In one embodiment of the present invention, a key generator (or part thereof) is embedded into a hardware device or an electronic chip (e.g. a programmable electronic chip).

### Applications

The present invention can for example be use in one of:
A financial application (e.g. a online banking application, an online investment application, a payment site, or an automatic teller machine).
A computer game (e.g. an online game, e.g. online poker).
A DRM application (e.g. license manager or a media player).
A security application (e.g. a VPN client, a remote desktop application, or an anti-virus application).
A distributed computing application (e.g. to verify authenticity of client applications).

### Unique and Random

When the term “unique” is used in this document on number or stings, it may includes randomly chosen numbers or string (e.g. generated by a PRNG) even though these can collide (i.e. there is a certain chance that the same number can be drawn more than once).

It should be understood that the method steps, structural details, functionalities and any other feature of any of the methods, computers, computer programs, servers, clients and any other invention described and embodimented herein, may be fully or partially applied in any other method, computer, computer program, server, client and any other invention described and embodimented herein, unless otherwise stated. Hence, all possible combinations of the presently embodimented and described inventions are within the scope of the present specification and embodiments.

### DESCRIPTION OF THE DRAWINGS

FIG. 1 illustrates three customers communicating with their bank over the Internet using their computers. The fourth user is an attacker. In a worst-case scenario, the attacker has full control over the Internet and the users' computers.

FIG. 2 illustrates the components involved in the communication between the user and the bank (i.e. the bank's internal computer systems). The user and the bank are considered secure, but all other components can be under the influence of an attacker.

FIG. 3 illustrates how the online banking program (the “netbank program”) can be secured by the present invention by having an embedded value or key generator. This value or key generator is used to authenticate the online banking program towards the bank, whereby the bank can make sure that the online banking program is authentic. The value or key generator may also be used to create a secure communication link between the program and the bank even if the computer or the Internet is compromised by an attacker. Finally, the value or key generator may be used to encrypt/decrypt data stored locally (the “netbank data”), again even if the computer is compromised.

FIG. 4 illustrates a key generator. Internally, it consists of two sub-functions: An extractor and a blender. The extractor takes an extractor IV as input and generates an extracted key. The extractor is usually unique for each copy of a program. The blender takes an extracted key and a blender IV and generates a purpose key.

FIG. 5 illustrates an extractor. W₁, W₂, W₃, and W₄ represents the initial values of the inner state words, which are being processed by n generator subfunction, F₁, F₂, . . . Fₙ. The resulting values of the inner state words are processed by a function L to generate an extracted key.

FIG. 6 illustrates an extractor. An extractor IV is used to generate four initial values of the inner state words by the K function. The extractor IV is also used to generate parameters for the generator subfunctions by the J function. The generator subfunctions, F₁, F₂, . . . Fₙ, manipulates the inner state words and uses each a constant, C₁, C₂, . . . Cₙ. The resulting inner state words are processed by the L function to obtain an extracted key.

FIG. 7 illustrates a client-server setup. Client programs are generated by a client program generator. The client generator stores the generated program files in a program file database and stores the generated program's serial number and PRNG seed in a SN/Seed database. When a user downloads a copy of the program from web server, the web server fetches one of the programs in the program database. When the client program communicates with a transaction server, the transaction server can look up the PRNG seed using the programs serial number as key. Using the PRNG seed, the transaction server can reproduce the functionality of the key generator embedded into the client program.

FIG. 8 illustrates a method for authenticating a computer-executable program file. A key generator IV is sent to a key generator (KG), to obtain a purpose key. The client program is processed by a function (F) and the resulting string is sent through a MAC function where the generated purpose key is used as MAC key. The resulting MAC tag is used as an authentication tag.

FIG. 9 illustrates a method for authenticating a computer-executable program file. A key generator IV is sent to a key generator (KG), to obtain a purpose key. The client program is divided into substrings. Each substring is processed by a hash function. The outputs from the hash functions are sent through a MAC function where the generated purpose key is used as MAC key. The resulting MAC tag is used as an authentication tag.

FIG. 10 illustrates a method for generating an encryption key and an authentication key. A key generator IV is sent to a key generator (KG), to obtain a purpose key. The client program is divided into substrings. Each substring is processed by a hash function. The outputs from the hash functions are sent through a MAC function where the generated purpose key is used as MAC key. One string is appended to the output of the MAC function and the resulting string is hashed. The result of this hash operation is used as an encryption key. Another string is appended to the output of the MAC function and the resulting string is hashed. The result of this hash operation is used as an authentication key.

FIG. 11 illustrates a method for storing a file encryption key. A key generator IV is stored in a file and is sent to a key generator (KG), to obtain a purpose key. The computer-executable program file is processed by a MAC function where the generated purpose key is used as MAC key. Hardware profile data is read on the computer the program runs on. This data is grouped. Each hardware profile group is processed with the output of the MAC function by a first hash function (upper H). The output from the first hash function is hashed again and the result is stored in the file. The output form the first hash function is also used to encrypt a key. The encrypted key is also stored in the file. An encrypted key and an output of the second hash function (lower H) are stored for each hardware profile group.

FIG. 12 illustrates a DRM system where a user acquires a playback device with an embedded key generator from a player vendor. The player vendor sends information about the key generator to a license manager such that the license manager can reproduce the key generator's functionality. Content is encryption and/or authenticated and sent to the user. The user downloads an encrypted key from the license manager. This key can be decrypted by the playback device in order to achieve the key(s) needed to decrypt or verify authenticity of the content.

FIG. 13 illustrates two functions (A and B) in a being merged into one. The call from the code of the original function A to the code from the original function B is changed to a local call. In the same way, the return from the code of the original function B is replaced by a local return statement. Furthermore, extra functionality is embedded into the resulting function in order to handle tasks previously handled by the runtime environment or operating system, e.g. allocating and feeing memory for temporary variables.

FIG. 14 illustrates a computer program (C) and a server (D). C has an embedded key generator (KG). D has a key generator emulator (KGE). If D knows the identity of C (e.g. knows its serial number), it can look up the seed value used to generate the key generator embedded into C from the serial number and seed database. This knowledge can be used by D's key generator emulator to emulate C's key generator. Thus, C and D can generate the same keys. These keys can be used to send data in protected form between C and D. This protection can consist of the data being encrypted and/or authenticated using key generated by C's KG and D's KGE.

FIG. 15 illustrates two computer programs (G and H) and a server (I). G and H each have an embedded unique key generator (KG). I has a key generator emulator (KGE). The key generator emulator can generate the same keys as the key generators in G and H provided that I knows the identity if G and H (e.g. by knowing their serial numbers). The key generator emulator can look up the seed values used to generate the key generators in G and H in the serial number/seed database. I can create a cryptographic key that can be sent in protected form (e.g. encrypted form) to both G and H (i.e. encrypted using keys that can be generated by the key generators of G and H respectively). When G and H shares the same key, they can send protected data between each other where this data is encrypted and/or authenticated using the shared key.

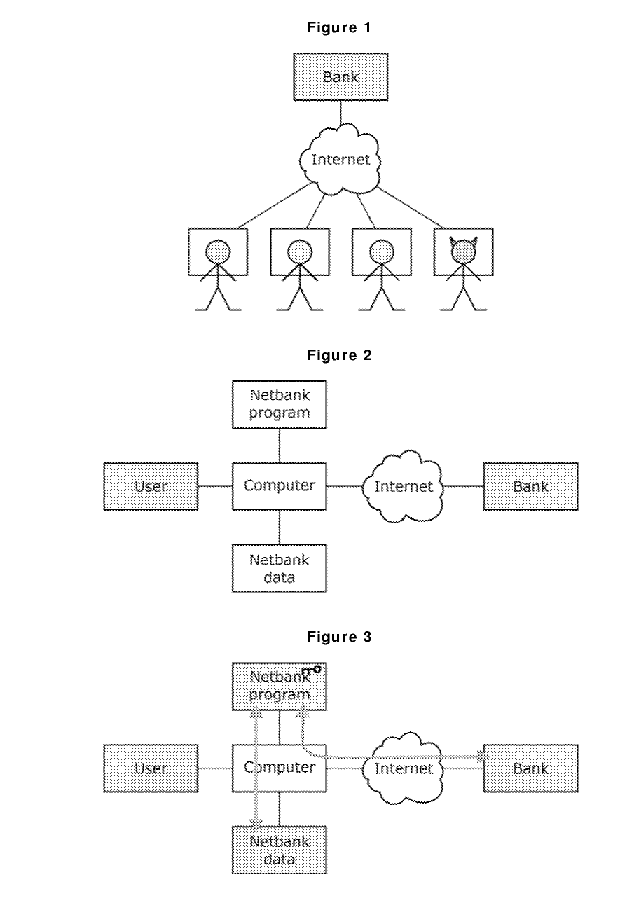

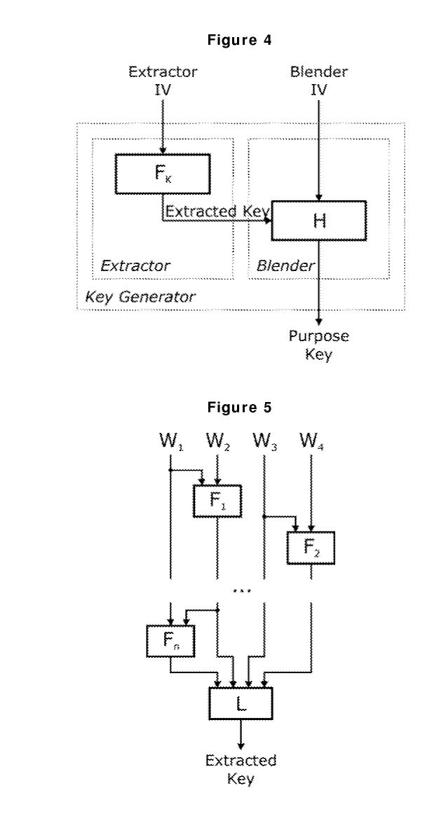

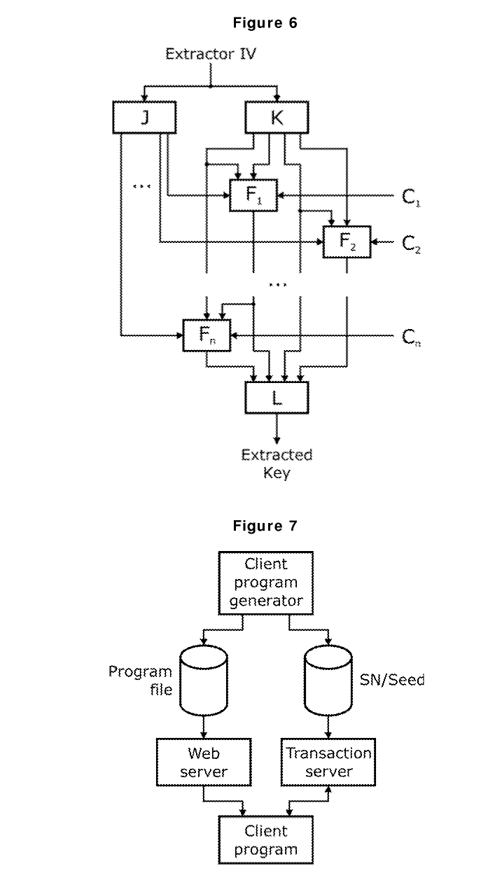

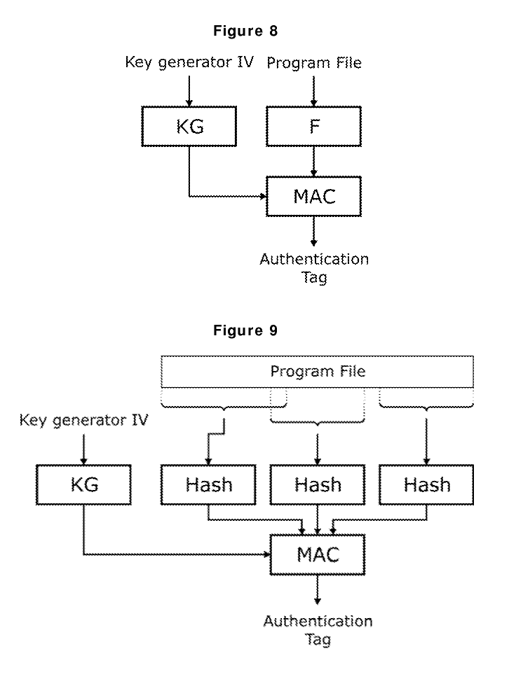

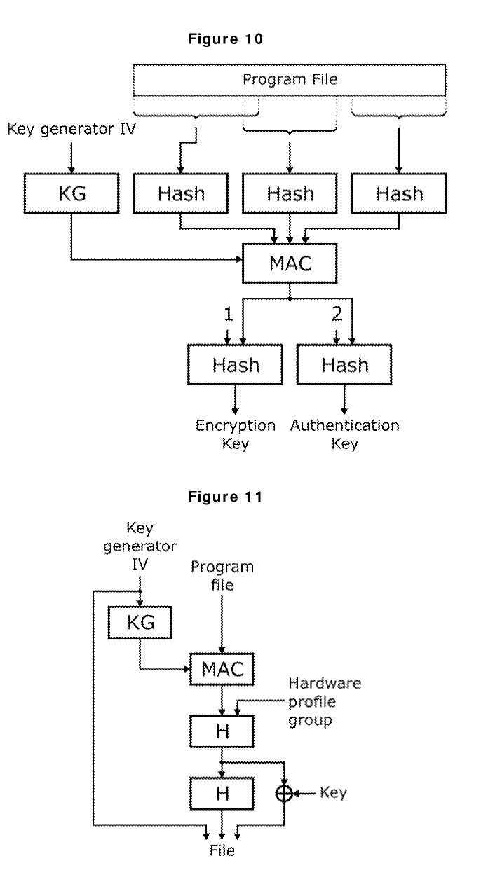

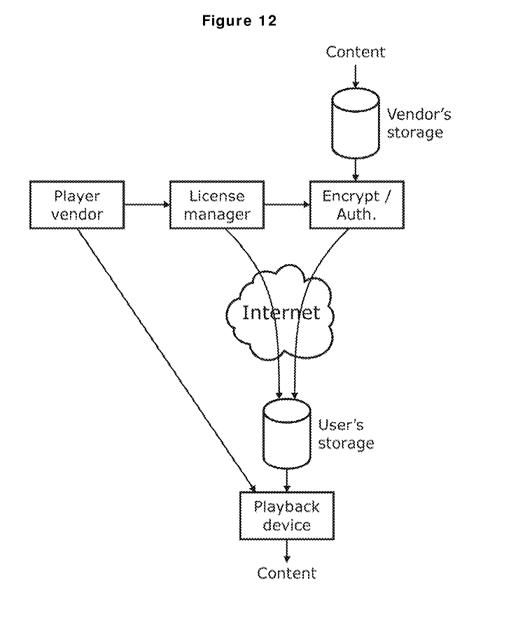

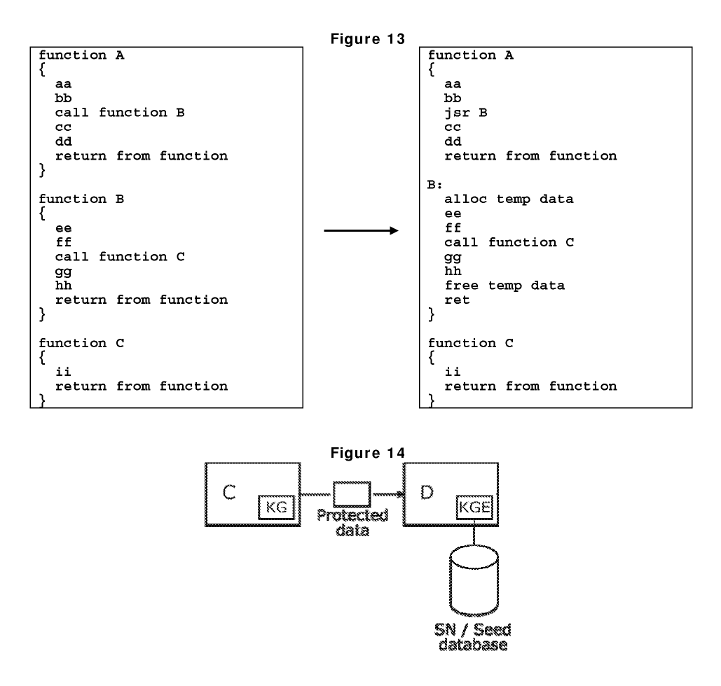

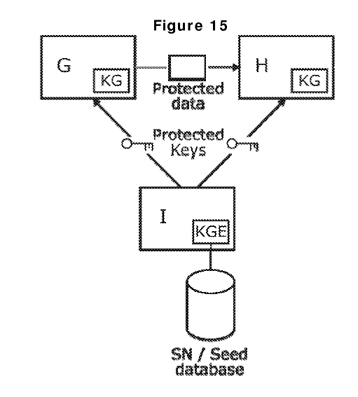

It should be understood that the present invention is not limited to the subject-matter of the appended claims. In particular, the embodiments outlined below form part of the present invention:

1. A method of fabricating computer-executable program files from a source code, the method comprising the step of embedding, in each of the fabricated computer-executable program files, at least one value or means for generating at least one value, said value being uniquely selected or generated for each of the fabricated computer-executable program files, whereby all of the fabricated computer-executable program files are capable of carrying out instructions defined by the source code, and whereby each individual computer-executable program file is capable of generating a unique output, which depends on said uniquely selected or uniquely generated value.

2. A method according to embodiment 1 where each user or group of users uses a different copy of the computer-executable program file.

3. A method according to embodiment 1 or 2 where the embedded means for generating at least one value depends on at least one embedded value.

4. A method according to any of embodiments 1-3 where the process of fabricating computer-executable program files from a source code is divided into at least two steps; a first step of converting source code into at least one intermediate file is performed once and a later step of converting at least one intermediate file and optionally other files into a computer-executable program file is performed for each computer-executable program file.

5. A method according to embodiment 4 where at least one of the intermediate files is a computer-executable program file, an object file, or a source code file.

6. A method according to any of the preceding embodiments where at least a part of the source code is evaluated to determine if it meets one or more predefined criteria for being equipped with the embedded at least one value or means for generating at least one value.

7. A method according to embodiment 4 or 5 where at least one of the intermediate files is evaluated to determine if it meets one or more predefined criteria for being equipped with the embedded at least one value or means for generating at least one value.

8. A method according to embodiment 6 or 7 where the criteria are defined by the organization providing the source code.

9. A method according to any of embodiments 6-8 where the criteria are defined such that the program cannot export sensitive data in an unprotected form.

10. A method according to any of embodiments 6-9 where the criteria are defines such that the program cannot manipulate sensitive data.

11. A method according to any of embodiments 6-10 where information about the criteria is distributed along with the fabricated computer-executable program file who's functionality is evaluated according to the criteria.

12. A method according to any of embodiments 1-11 where the embedded means for generating at least one value comprises at least one extractor subfunctions, the extractor subfunctions have been selected from a set of available extractor subfunctions.

13. A method according to embodiment 12 where the extractor subfunctions are uniquely selected for each computer-executable program file.

14. A method according to embodiment 12 or 13 where at least one extractor subfunctions depend on at least one inner state word and generate at least one inner state word.

15. A method according to any of embodiments 1-11 where the embedded means for generating at least one value comprises at least one extractor subfunction.

16. A method according to embodiment 15 where at least one of the extractor subfunctions is uniquely selected for each computer-executable program file.

17. A method according to embodiment 15 or 16 where at least one of the extractor subfunctions is selected from a set of available extractor subfunctions.

18. A method according to any of embodiments 15-17 where at least one of the extractor subfunctions depend on at least one inner state word and generate at least one inner state word.

19. A method according to any of embodiments 12-18 where at least one extractor subfunction depends on a value derived from a key generator initialization vector (key generator IV) where the key generator IV is given as argument to the embedded means for generating at least one value.

20. A method according to any of embodiments 12-19 where at least one extractor subfunction depends on at least one embedded value.

21. A method according to any of embodiments 12-20 where at least one extractor subfunction comprises at least one of:
a bijective operation,
an arithmetical operation,
a logical operation,
a table lookup, and
an embedded value.

22. A method according to any of embodiments 12-21 where the initial value of at least one inner state word depends on a key generator IV.

23. A method according to any of embodiments 12-22 where the output from at least one extractor subfunction or a value derived thereof is used as input to a cryptographic function.

24. A method according to embodiment 23 where the cryptographic function is a hash function.

25. A method according to embodiment 24 where the hash function also depends on at least a part of the key generator IV.

26. A method according to any of embodiments 12-25 where the output from at least one extractor subfunction or a value derived thereof is used as a cryptographic key.

27. A method according to any of embodiments 1-26 where the embedded at least one value or means for generating at least one value is used to derive a cryptographic key.

28. A method according to any of embodiments 1-27 where an embedded value, a value derived thereof, a value generated by means for generating at least one value, or a value derived thereof is used as input to a cryptographic algorithm where the output of the cryptographic algorithm is used as a cryptographic key.

29. A method according to any of embodiments 1-28 where the embedded at least one value or means for generating at least one value is used to authenticate a computer program.

30. A method according to any of embodiments 1-29 where the embedded at least one value or means for generating at least one value is used as a serial number or to derive a serial number that can be used to identify the copy of the computer program.

31. A method according to any of embodiments 1-26 where the embedded at least one value or output from means for generating at least one value is combined with at least one of:
data from the user,
data about the user,
data from something the user possesses, and
data from the computer the program runs on
   to obtain a resulting value.

32. A method according to any of embodiments 1-26 where the means for generating at least one value depends on at least one of:
data from the user,
a data about the user,
data from something the user possesses, and
data from the computer that program runs on
   in order to generate a resulting value.

33. A method according to embodiment 31 or 32 where the resulting value is used as a cryptographic key or to obtain a cryptographic key.

34. A method according to any of embodiments 26, 27, 28, or 33 where the cryptographic key is used to encrypt or decrypt data.

35. A method according to embodiment 34 where the cryptographic key is used to encrypt data to be stored or to decrypt data that has been stored.

36. A method according to embodiment 34 where the cryptographic key is used to encrypt data to be transmitted or to decrypt data that has been transmitted.

37. A method according to any of embodiments 26, 27, 28, or 33 where the cryptographic key is used to generate an authentication tag.

38. A method according to embodiment 37 where the authentication tag is appended to data to be stored or is extracted from data that has been stored.

39. A method according to embodiment 37 where the authentication tag is used to authenticate stored data.

40. A method according to embodiment 37 where the authentication tag is appended to data to be transmitted or is extracted and from data that has been transmitted.

41. A method according to embodiment 37 where the authentication tag is used to authenticate transmitted data.

42. A method according to any of embodiments 37-41 where the authentication tag is used to authenticate at least a part of a computer program.

43. A method according to any of embodiments 37-42 where the correctness of the authentication tag is verified by a server.

44. A method according to any of embodiments 37-43 where the correctness of the authentication tag is verified by a hardware device.

45. A method according to any of the preceding embodiments where information about how a computer-executable program file is generated is stored such that the computer-executable program file can be reproduced or its functionality or part thereof can be reproduced or simulated.

46. A method according to embodiment 45, wherein the stored information about the computer-executable program file is used in a computer program and/or hardware device to reproduce at least a part of the at least one embedded value or to simulate at least a part of the embedded means for generating at least one value.

47. A method of fabricating computer-executable program files according to any of the preceding embodiments comprising the following steps:
1. choosing a PRNG seed,
2. generating a set of pseudo-random values from the PRNG seed using a pseudo-random number generator,
3. using the set of pseudo-random values to determine at least one embedded value or how to construct the embedded means for generating at least one value.

48. A method of fabricating computer-executable program files according to any of the preceding embodiments comprising the following steps:
1. choosing a PRNG seed,
2. generating a string of pseudo-random bits from the PRNG seed using a pseudo-random number generator,
3. using the string of pseudo-random bits to determine at least one embedded value or how to construct the embedded means for generating at least one value.

49. A method according to embodiment 47 or 48 where the PRNG seed is stored for later use.

50. A method according to any of embodiments 47-49 where the PRNG seed is used to generate the set of pseudo-random values again; the set of value is used to recreate at least one embedded value or the embedded means for generating at least one value.

51. A method according to any of embodiments 47-50 where the PRNG seed is used to generate the string of pseudo-random bits again; the string of bits is used to recreate at least one embedded value or the embedded means for generating at least one value.

52. A method according to any of embodiments 47 to 51 where the PRNG seed is used to allow a computer program or a hardware device to create the same cryptographic key as a computer-executable program file being executed; the PRNG seed is used to reproduce the embedded at least one value or means for generating at least one value embedded into the computer executable program file on the computer program or hardware device such that both parties can generate the same cryptographic keys derived from the embedded at least one value or means for generating at least one value.

53. A method according to any of the preceding embodiments where a new version of a computer-executable program file is sent to a user; the new version has the same embedded at least one value or means for generating at least one value as the previous version.

54. A method according to any of the preceding embodiments where a computer-executable program file with an embedded at least one value for means for generating at least one value downloads or in another way acquires another computer-executable program file with the same embedded at least one value for means for generating at least one value.

55. A method according to any of the preceding embodiments where the embedded at least one value or means for generating at least one value is copied from one computer-executable program file to another computer-executable program file.

56. A method according to any of the preceding embodiments where information about program file's embedded at least one value or means for generating at least one value is stored; when a computer-executable program file is updated, this information is updated.

57. A method according to any of the preceding embodiments where information about a program file's embedded at least one value or means for generating at least one value is stored; when the computer-executable program file is updated, this information is updated.

58. A method according to any of the preceding embodiments where information about a program file's embedded at least one value or means for generating at least one value is stored in a database; when the computer-executable program file is updated, its record in the database is updated.

59. A method according to any of the preceding embodiments where the computer-executable program files are obfuscated.

60. A method according to embodiment 59 where the obfuscation method comprises means for at least one of:
replacing a program instruction or a set of program instructions with at least one new program instruction with equivalent functionality,
reallocating registers,
reordering program instructions,
adding or removing jump instructions,
inserting useless data or program instructions into the computer program,
interleaving at least two program sequences,
reordering static data, and
reordering runtime data.

61. A method according to any of the preceding embodiments where at least a part of the computer-executable program file is stored in encrypted form and is decrypted at runtime.

62. A method according to embodiment 61 where the key to decrypt the encrypted at least a part of the computer-executable program code is downloaded from a server.

63. A method according to embodiment 62 where the encrypted part of the computer-executable program file is decrypted using a cryptographic key derived from the embedded at least one value or means for generating at least one value.

64. A method according to any of the preceding embodiments where a computer-executable program file with embedded at least one value or means for generating at least one value decrypts another computer-executable program file.

65. A method according to any of the preceding embodiments where the destination address of at least one jump instruction in the computer-executable program file is read from a table.

66. A method according to any of the preceding embodiments where at least one parameter to at least one instruction in the computer-executable program file is read from a table.

67. A method according to embodiment 65 or 66 where the at least one entry in the table has a pre-defined value stored in the computer-executable file.

68. A method according to any of embodiments 65-67 where at least one entry in the table is downloaded from a server.

69. A method according to any of embodiments 65-68 where at least one entry in the table is decrypted at runtime.

70 A method according to embodiment 68 or 69 where at least one downloaded or decrypted value replaces at least one pre-defined value in the table.

71. A method according to embodiment 69 or 70 where the decryption key is derived from the embedded at least one value or means for generating at least one value.

72. A method according to embodiment 69 or 70 where the decryption key is derived from a string downloaded from a server.

73. A method according to any of the preceding embodiments where a computer-executable program file with at least one embedded value or embedded means for generating at least one value contains program code that can read profile data, the profile data comprises at least one of:
brand, type, version, or serial number of a hardware component,
brand, type, version, or serial number of a software component,
software or hardware configuration data,
network configuration data, and
identity of the user.

74. A method according to embodiment 73 where profile data is used as input to the means for generating at least one value.

75. A method according to any of the preceding embodiments where a computer program (A) communicating with a computer-executable program file with at least one embedded value or embedded means for generating at least one value (B); A can read profile data related to B, the computer B runs on, or the user using B.

76. A method according to any of embodiments 73-75 where profile data is used to detect if the computer-executable program file runs on the right computer.

77. A method according to any of the preceding embodiments where data sent between program C and D is encrypted/decrypted; the encryption/decryption key is derived from the embedded at least one value or means for generating at least one value in program C; the encryption/decryption key is derived from knowledge about the embedded at least one value or means for generating at least one value in C by program D.

78. A method according to any of the preceding embodiments where data is sent in encrypted form between programs C and D; the encryption/decryption key is derived from the embedded at least one value or means for generating at least one value in program C; the encryption/decryption key is derived in program D from knowledge about the embedded at least one value or means for generating at least one value in C.

79. A method according to any of the preceding embodiments where data sent between program E and F is authenticated; the authentication key is derived from the embedded at least one value or means for generating at least one value in program E; the authentication key is derived from knowledge about the embedded at least one value or means for generating at least one value in E by program F.

80. A method according to any of embodiments 77-79 where one party in a communication selects a key generator IV; the key generator IV is sent to the other party; both parties uses the key generator IV to derive a key that can be used for encryption/decryption or authentication.

81. A method according to any of embodiments 77-79 where both parties in a communication selects a part of a key generator IV; the parts are communicated; a key generator IV is derived in both ends from the parts; both parties uses the constructed key generator IV to derived a key that can be used for encryption/decryption or authentication.

82. A method according to any of the preceding embodiments where data is sent in encrypted form between programs G and H where G and H both communicates securely with server I using cryptographic keys derived from G's and H's embedded at least one value or means for generating at least one value; the server I provides at least one cryptographic key to G and H to be used to encrypt/decrypt at least a part of the data sent between G and H.

83. A method according to any of the preceding embodiments where data is sent in authenticated form between programs J and K where J and K both communicates securely with server L using cryptographic keys derived from J's and K's embedded at least one value or means for generating at least one value; the server L provides at least one cryptographic key to J and K to be used to authenticate at least a part of the data sent between J and K.

84. A method according to any of the preceding embodiments where at least one cryptographic key is negotiated between programs M and N where M and N both communicates securely with server Q using cryptographic keys derived from M's and A's embedded at least one value or means for generating at least one value

85. A method according to embodiment 84 where O provides the same cryptographic key to M and N.

86. A method according to embodiment 84 or 85 where at least one of the at least one cryptographic keys is used to encrypt/decrypt data sent between M and N.

87. A method according to any of embodiments 84-86 where at least one of the at least one cryptographic keys is used to authenticate data sent between M and N.

88. A method according to any of embodiments 1-81 where data is sent in encrypted form between programs P and Q; P derives the encryption/decryption key from its embedded at least one value or means for generating at least one value; Q receives the encryption/decryption key from a server.

89. A method according to any of embodiments 1-81 where data sent between programs R and S is authenticated; R derives the authentication key from its embedded at least one value or means for generating at least one value; S receives the authenticate key from a server.

90. A method according to any of embodiments 82-89 where the two programs run on the same computer.

91. A method according to embodiment 90 where the two programs read profile data and compare these to verify that they run on the same computer.

92. A method according to any of embodiments 82-89 where the two programs run on different computers.

93. A method according to any of the preceding embodiments where key exchange protocol data is encrypted or decrypted using a cryptographic key derived from an embedded at least one value or means for generating at least one value.

94. A method according to any of the preceding embodiments where key exchange protocol data is authenticated using a cryptographic key derived from an embedded at least one value or means for generating at least one value.

95. A method according to embodiment 93 or 94 where the key exchange protocol is the Diffie-Hellman protocol.

96. A method according to any of embodiments 93-95 where the key exchange protocol is used to derive a symmetrical cryptographic key.

97. A method according to any of the preceding embodiments where an asymmetric key is encrypted or decrypted using a cryptographic key derived from an embedded at least one value or means for generating at least one value.

98. A method according to any of the preceding embodiments where an asymmetric key is authenticated using a cryptographic key derived from an embedded at least one value or means for generating at least one value.

99. A method according to embodiment 97 or 98 where the asymmetric key is a public RSA key or a private RSA key.

100. A method according to embodiment 97 or 98 where the asymmetric key is a public ECC key or a private ECC key.

101. A method according to any of embodiments 97-100 where the asymmetric key is used to derive a symmetrical cryptographic key.

102. A method according to embodiment 96 or 101 where the symmetrical key is used to encrypt or decrypt data.

103. A method according to any of embodiments 96, 101, and 102 where the symmetrical key is used to authenticate data.

104. A method according to any of the preceding embodiments where data to be stored is encrypted or data that has been stored is decrypted; the encryption/decryption key is derived from the embedded at least one value or means for generating at least one value.

105. A method according to any of the preceding embodiments where data to be stored or that has been stored is processed in order to generate an authentication tag; the authentication key is derived from the embedded at least one value or means for generating at least one value.

106. A method according to embodiment 104 or 105 where a key generator IV is used to derive the encryption/decryption key or authentication key; the key generator IV is stored with the data.

107. A method according to embodiment 104 or 105 where a value stored with the data is hashed with profile data to obtain a key generator IV used to derive the encryption/decryption key or authentication key.

108. A method according to any of the preceding embodiments where a cryptographic key is stored in encrypted form; the decryption key to be used to decrypt the cryptographic key is derived from the embedded at least one value or means for generating at least one value.

109. A method according to any of the preceding embodiments where a cryptographic key is stored in encrypted form; the decryption key to be used to decrypt the cryptographic key is downloaded from a server.

110. A method according to any of the preceding embodiments where a computer program or a computer-executable program file is authenticated using an authentication key derived from the embedded at least one value or means for generating at least one value.

111. A method according to embodiment 110 where a computer program or a computer-executable program file is authenticated towards another computer program or a hardware device.

112. A method according to embodiment 110 or 111 where a computer program is calculating an authentication tag on itself.

113. A method according to any of the preceding embodiments where an authentication tag is calculated on a computer program, a computer-executable program file, or a data file; the authentication key is derived from an embedded at least one value or means for generating at least one value, the authentication tag is compared to one stored with the program or data to verify if the program or data is authentic and if the stored tag was generated by someone with knowledge about the embedded at least one value or means for generating at least one value.

114. A method according to embodiment 113 where the embedded at least one value or means for generating at least one value is stored on a device and the program or file to be authenticated is a program the be executed or accessed on that device.

115. A method according to embodiment 113 or 114 where the stored authentication tag is generated with knowledge about the embedded at least one value or means for generating at least one value.

116. A method according to any of the preceding embodiments where a computer-executable program file with the embedded at least one value or means for generating at least one value is used to play back digital content.

117. A method according to any of the preceding embodiments where digital content is distributed in encrypted form; the encrypted content is decrypted by a computer-executable program file with an embedded at least one value or means for generating at least one value in order to play back the digital content.

118. A method of generating a media player with at least one uniquely selected value or at least one value generated by uniquely selected means is used to play back digital content produced by a method according to any of the preceding embodiments.

119. A method of distributing a decryption key for digital content to a playback device; the playback device is constructed by a method according to any of the preceding embodiments.

120. A method according to any of the preceding embodiments where the fabricated computer-executable program file is tested to verify if it works as intended.

121. A method according to any of the preceding embodiments where at least one fabricated computer-executable program file is inserted into another file.

122. A server from which computer-executable program files fabricated according to any of the preceding embodiments can be downloaded.

123. A server communicating with a computer-executable program file fabricated according to any of the preceding embodiments.

124. A file written by a computer-executable program file fabricated according to any of the preceding embodiments.

125. An file encrypted using a key; the decryption key can be derived or decrypted using at an embedded at least one value or means for generating at least one value in a computer-executable program file fabricated according to any of the preceding embodiments.

126. Data sent over a network; the data is encrypted by a computer-executable program file fabricated according to any of embodiments any of the preceding embodiments.

127. Data sent over a network; the data is encrypted using a key; the decryption key can be derived or decrypted using an embedded at least one value or means for generating at least one value in a computer-executable program file fabricated according to any of embodiments any of the preceding embodiments.

128. Data sent over a network; the data is authenticated by a computer-executable program file fabricated according to any of the preceding embodiments.

129. Data sent over a network; the data is authenticated using a key; the decryption key can be derived or decrypted using an embedded at least one value or means for generating at least one value in a computer-executable program file fabricated according to any of the preceding embodiments.

130. A document into which at least one computer-executable program file fabricated according to any of the preceding embodiments is embedded.

131. A computer on which at least one computer-executable program file fabricating according to any of the preceding embodiments is stored or executed.

132. A computer program for fabricating computer-executable program files from source code, the computer program comprising means for performing the method of any of the preceding embodiments.

133. A computer-readable data medium comprising a computer program according to embodiment 132.

134. A computer loaded with a computer program according to embodiment 132.

135. A computer-executable program file fabricated by a method according to any of embodiments 1-121.

136. A method according to any of the preceding embodiments of fabricating computer-executable program files according to any of embodiments 137-300.

137. A computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

138. A computer program according to embodiment 137, wherein the computer-executable program file is fabricated by a method according to any of embodiments 1-136.

139. A computer-readable data medium comprising a computer program according to embodiment 137 or 138.

140. A computer loaded with a computer program according to embodiment 139.

141. A computer program according to any of embodiments 137-140 where the embedded means for generating at least one value comprises at least one extractor subfunction.

142. A computer program according to embodiment 141 where at least one of the extractor subfunctions is uniquely selected for each computer-executable program file.

143. A computer program according to embodiment 141 or 142 where at least one of the extractor subfunctions is selected from a set of available extractor subfunctions.

144. A computer program according to any of embodiments 141-143 where at least one of the extractor subfunctions depends on at least one inner state word and generates at least one inner state word.

145. A computer program according to any of embodiments 141-144 where at least one of the extractor subfunctions depends on a value derived from a key generator initialization vector (key generator IV) where the key generator IV is given as argument to the embedded means for generating at least one value.

146. A computer program according to any of embodiments 141-145 where at least one of the extractor subfunctions depends on at least one embedded value.

147. A computer program according to any of embodiments 141-146 where at least one of the extractor subfunctions comprises at least one of:
a bijective operation,
an arithmetical operation,
a logical operation,
a table lookup, and
an embedded value.

148. A computer program according to any of embodiments 141-147 where the initial value of at least one of the inner state word depends on a key generator IV.

149. A computer program according to any of embodiments 141-148 where the output from at least one of the extractor subfunction or a value derived thereof is used as input to a cryptographic function.

150. A computer program according to embodiment 149 where the cryptographic function is a hash function.

151. A computer program according to embodiment 150 where the hash function also depends on at least a part of the key generator IV.

152. A computer program according to any of embodiments 141-149 where the output from at least one of the extractor subfunction or a value derived thereof is used as a cryptographic key.

153. A computer program according to any of embodiments 137-152 where at least one embedded value is changed at runtime.

154. A computer program according to any of embodiments 137-153 where at least one of the at least one embedded uniquely selected values is changed at runtime.

155. A computer program according to embodiment 153 or 154 where the new value of an embedded value is read from a file.

156. A computer program according to any of embodiments 153-155 where the new value of an embedded value is received from a server.

157. A computer program according to any of embodiments 137-156 where at least one embedded value is replaced with a value obtained from a cryptographic function.

158. A computer program according to embodiment 157 where the cryptographic function is a pseudo-random number generator.

159. A computer program according to 137-158 where at least one embedded value is encrypted or decrypted using a cryptographic algorithm.

160. A computer program according to embodiment 158 or 159 where the PRNG seed or cryptographic key is read from a file.

161. A computer program according to embodiment 158 or 159 where the PRNG seed or cryptographic key is received from a server.

162. A computer program according to any of embodiments 137-161 where the embedded at least one value or means for generating at least one value is used to derive a cryptographic key.

163. A computer program according to any of embodiments 137-162 where an embedded value, a value derived thereof, a value generated by means for generating at least one value, or a value derived thereof is used as input to a cryptographic algorithm where the output of the cryptographic algorithm is used as a cryptographic key.

164. A computer program according to any of embodiments 137-163 where the embedded at least one value or means for generating at least one value is used to authenticate a computer program.

165. A computer program according to any of embodiments 137-164 where the embedded at least one value or means for generating at least one value is used as a serial number or to derive a serial number that can be used to identify the copy of the computer program.

166. A computer program according to any of embodiments 137-165 where the embedded at least one value or output from means for generating at least one value is combined with at least one of:
data from the user,
data about the user,
data from something the user possesses, and
data from the computer the program runs on
   to obtain a resulting value.

167. A computer program according to any of embodiments 137-166 where the means for generating at least one value depends on at least one of:
data from the user,
data about the user,
data from something the user possesses, and
data from the computer that program runs on
   in order to generate a resulting value.

168. A computer program according to embodiment 137 or 167 where the resulting value is used as a cryptographic key or to obtain a cryptographic key.

169. A computer program according to any of embodiments 152, 162, 163, or 168 where the cryptographic key is used to encrypt or decrypt data.

170. A computer program according to embodiment 169 where the cryptographic key is used to encrypt data to be stored or to decrypt data that has been stored.

171. A computer program according to embodiment 169 where the cryptographic key is used to encrypt data to be transmitted or to decrypt data that has been transmitted.

172. A computer program according to any of embodiments 152, 162, 163, or 168 where the cryptographic key it used to generate an authentication tag.

173. A computer program according to embodiment 172 where the authentication tag is appended to data to be stored or is extracted from data that has been stored.

174. A computer program according to embodiment 172 where the authentication tag is used to authenticate data that has been stored.

175. A computer program according to embodiment 172 where the authentication tag is appended to data to be transmitted or is extracted and from data that has been transmitted.

176. A computer program according to embodiment 172 where the authentication tag is used to authenticate data that has been transmitted.

177. A computer program according to any of embodiments 172-176 where the authentication tag is used to authenticate at least a part of a computer program.

178. A computer program according to any of embodiments 172-177 where the correctness of the authentication tag is verified by a server.

179. A computer program according to any of embodiments 172-178 where the correctness of the authentication tag is verified by a hardware device.

180. A computer program according to any of embodiments 137-179 where a check sum is calculated on a software module; the check sum is compared to an expected value to determine of the software module is authentic.

181. A computer program according to embodiment 180 where the check sum is calculated by a cryptographic function.

182. A computer program according to embodiment 181 where the cryptographic functions is a hash function.

183. A computer program according to any of embodiments 137-182 where a new version of a computer-executable program file is sent to a user; the new version has the same embedded at least one value or means for generating at least one value as the previous version.

184. A computer program according to any of embodiments 137-183 where a computer-executable program file with an embedded at least one value for means for generating at least one value downloads or in another way acquires another computer-executable program file with the same embedded at least one value for means for generating at least one value.

185. A computer program according to any of embodiments 137-184 where the embedded at least one value or means for generating at least one value is copied from one computer-executable program file to another computer-executable program file.

186. A computer program according to any of embodiments 137-185 where information about a program file's embedded at least one value or means for generating at least one value is stored; when the computer-executable program file is updated, this information is updated.

187. A computer program according to any of embodiments 137-185 where information about a program file's embedded at least one value or means for generating at least one value is stored in a database; when the computer-executable program file is updated, its record in the database is updated.

188. A computer program according to any of embodiments 137-187 where the computer program is obfuscated.

189. A computer program according to embodiment 188 where the obfuscation method comprises means for at least one of:
replacing a program instruction or a set of program instructions with at least one new program instruction with equivalent functionality,
reallocating registers,
reordering program instructions,
adding or removing jump instructions,
inserting useless data or program instructions into the computer program,
interleaving at least two program sequences,
reordering static data, and
reordering runtime data.

190. A computer program according to any of embodiments 137-189 where at least a part of the computer-executable program file is stored in encrypted form and is decrypted at runtime.

191. A computer program according to embodiment 190 where the key to decrypt the encrypted at least a part of the computer-executable program code is downloaded from a server.

192. A computer program according to embodiment 190 where the encrypted part of the computer-executable program file is decrypted using a cryptographic key derived from the embedded at least one value or means for generating at least one value.

193. A computer program according to any of embodiments 137-192 where a computer-executable program file with embedded at least one value or means for generating at least one value decrypts another computer-executable program file.

194. A computer program according to any of embodiments 137-193 where the destination address of at least one jump instruction in the computer-executable program file is read from a table.

195. A method according to any of embodiments 137-194 where at least one parameter to at least one instruction in the computer-executable program file is read from a table.

196. A computer program according to embodiment 194 or 195 where the at least one entry in the table has a pre-defined value stored in the computer-executable file.

197. A computer program according to any of embodiments 194-196 where at least one entry in the table is downloaded from a server.

198. A computer program according to any of embodiments 194-197 where at least one entry in the table is decrypted at runtime.

199. A computer program according to embodiment 197 or 198 where at least one downloaded or decrypted value replaces at least one pre-defined value in the table.

200. A computer program according to embodiment 198 or 199 where the decryption key is derived from the embedded at least one value or means for generating at least one value.

201. A computer program according to embodiment 198 or 199 where the decryption key is downloaded from a server.

202. A computer program according to any of embodiments 137-201 capable of reading profile data, the profile data comprises at least one of:
brand, type, version, or serial number of a hardware component,
brand, type, version, or serial number of a software component,
software or hardware configuration data,
network configuration data, and
identity of the user.

203. A computer program according to embodiment 202 where profile data is used as input to the means for generating at least one value.

204. A computer program according to embodiment 202 or 203 where profile data is used to detect if the computer program runs on the right computer.

205. A computer program according to any embodiments 137-204 where data sent between program C and D is encrypted/decrypted; the encryption/decryption key is derived from the embedded at least one value or means for generating at least one value in program C; the encryption/decryption key is derived from knowledge about the embedded at least one value or means for generating at least one value in C by program D.

206. A computer program according to embodiments 137-205 where data is sent in encrypted form between programs C and D; the encryption/decryption key is derived from the embedded at least one value or means for generating at least one value in program C; the encryption/decryption key is derived from knowledge about the embedded at least one value or means for generating at least one value in C by program D.

207. A computer program according to embodiments 137-206 where data sent between program E and F is authenticated; the authentication key is derived from the embedded at least one value or means for generating at least one value in program E; the authentication key is derived from knowledge about the embedded at least one value or means for generating at least one value in E by program F.

208. A computer program according to any of embodiments 205-207 where one party in a communication selects a key generator IV; the key generator IV is sent to the other party; both parties uses the key generator IV to derive a key that can be used for encryption/decryption or authentication.

209. A computer program according to any of embodiments 205-207 where both parties in a communication selects a part of a key generator IV; the parts are communicated; a key generator IV is derived in both ends from the parts; both parties uses the constructed key generator IV to derived a key that can be used for encryption/decryption or authentication.

210. A computer program (G) according to any of embodiments 137-209 where data is sent in encrypted form between programs G and H where G and H both communicates securely with server I using cryptographic keys derived from G's and H's embedded at least one value or means for generating at least one value; the server I provides at least one cryptographic key to G and H to be used to encrypt/decrypt at least a part of the data sent between G and H.

211. A computer program (J) according to any of embodiments 137-210 where data is sent in authenticated form between programs J and K where J and K both communicates securely with server L using cryptographic keys derived from J's and K's embedded at least one value or means for generating at least one value; the server L provides at least one cryptographic key to J and K to be used to authenticate at least a part of the data sent between J and K.

212. A computer program (M) according to any of embodiments 137-211 where at least one cryptographic key is negotiated between programs M and N where M and N both communicates securely with server O using cryptographic keys derived from M's and N's embedded at least one value or means for generating at least one value

213. A computer program according to embodiment 212 where O provides the same cryptographic key to M and N.

214. A computer program according to embodiment 212 or 213 where at least one of the at least one cryptographic keys is used to encrypt/decrypt data sent between M and N.

215. A computer program according to any of embodiments 212-214 where at least one of the at least one cryptographic keys is used to authenticate data sent between M and N.

216. A computer program (P) according to any of embodiments 137-209 where data is sent in encrypted form between programs P and Q; P derives the encryption/decryption key from its embedded at least one value or means for generating at least one value; Q receives the encryption/decryption key from a server.

217. A computer program (Q) according to any of embodiments 137-209 where data is sent in encrypted form between programs P and a; P derives the encryption/decryption key from its embedded at least one value or means for generating at least one value; Q receives the encryption/decryption key from a server.

218. A computer program (R) according to any of embodiments 137-209 where data sent between programs R and S is authenticated; R derives the authentication key from its embedded at least one value or means for generating at least one value; S receives the authenticate key from a server.

219. A computer program (S) according to any of embodiments 137-209 where data sent between programs R and S is authenticated; R derives the authentication key from its embedded at least one value or means for generating at least one value; S receives the authenticate key from a server.

220. A computer program according to any of embodiments 210-219 where the two communicating programs run on the same computer.

221. A computer program according to embodiment 220 where the two communicating programs read profile data and compare these to verify that they run on the same computer.

222. A computer program according to any of embodiments 210-219 where the two communicating programs run on different computers.

223. A computer program according to any of embodiments 202-222 where the two computer programs communicating is a computer program and a software module loaded by the computer program.

224. A computer program according to embodiment 223 where the software module is a .dll file.

225. A computer program according to any of embodiments 137-224 where key exchange protocol data is encrypted or decrypted using a cryptographic key derived from an embedded at least one value or means for generating at least one value.

226. A computer program according to any of embodiments 137-225 where key exchange protocol data is authenticated using a cryptographic key derived from an embedded at least one value or means for generating at least one value.

227. A compute program according to embodiment 225 or 226 where the key exchange protocol is the Diffie-Hellman protocol.

228. A computer program according to any of embodiments 225-227 where the key exchange protocol is used to derive a symmetrical cryptographic key.

229. A computer program according to any of embodiments 137-228 where an asymmetric key is encrypted or decrypted using a cryptographic key derived from an embedded at least one value or means for generating at least one value.

230. A computer program according to any of embodiments 137-229 where an asymmetric key is authenticated using a cryptographic key derived from an embedded at least one value or means for generating at least one value.

231. A computer program according to embodiment 229 or 230 where the asymmetric key is a public RSA key or a private RSA key.

232. A computer program according to embodiment 229 or 230 where the asymmetric key is a public ECC key or a private ECC key.

233. A computer program according to any of embodiments 229-232 where the asymmetric key is used to derive a symmetrical cryptographic key.

234. A computer program according to embodiment 228 or 233 where the symmetrical key is used to encrypt or decrypt data.

235. A computer program according to any of embodiments 228, 233, and 234 where the symmetrical key is used to authenticate data.

236. A computer program according to any of embodiments 137-235 where data to be stored is encrypted or data that has been stored is decrypted; the encryption/decryption key is derived from the embedded at least one value or means for generating at least one value.

237. A computer program according to any of embodiments 137-236 where data to be stored or that has been stored is processed in order to generate an authentication tag; the authentication key is derived from the embedded at least one value or means for generating at least one value.

238. A computer program according to embodiment 236 or 237 where a key generator IV is used to derive the encryption/decryption key or authentication key; the key generator IV is stored with the data.

239. A computer program according to embodiment 236 or 237 where a value stored with the data is hashed with profile data to obtain a key generator IV used to derive the encryption/decryption key or authentication key.

240. A computer program according to any of embodiments 138-239 where a cryptographic key is stored in encrypted form; the decryption key to be used to decrypt the cryptographic key is derived from the embedded at least one value or means for generating at least one value.

241. A computer program according to any of embodiments 137-240 where a cryptographic key is stored in encrypted form; the decryption key to be used to decrypt the cryptographic key is downloaded from a server.

242. A computer program according to any of embodiments 137-241 where credit card information is encrypted or decrypted using a cryptographic key derived from the embedded at least one value or means for generating at least one value.

243. A computer program according to any of embodiments 137-242 where payment authorization data is encrypted or decrypted using a cryptographic key derived from the embedded at least one value or means for generating at least one value.

244. A computer program according to embodiment 243 where the payment authorization data comprises a credit card number.

245. A computer program according to embodiment 243 or 244 where the payment authorization data comprises a one-time password or one-time key.

246. A computer program according to any of embodiments 137-245 inserted into a file.

247. A server from which computer programs according to any of embodiments 137-246 can be downloaded.

248. A server according to embodiment 247 which has different versions of the computer program to be downloaded; the server decides which one to send according to predefined criteria.

249. A server according to embodiment 248 where the decision depends on knowledge about the computer downloading the computer program.

250. A server communicating with at computer program according to any of embodiments 137-246.

251. A file written by computer program according to any of embodiments 137-246.

252. An file encrypted using a key; the decryption key can be derived or decrypted using at an embedded at least one value or means for generating at least one value in a computer program according to any of embodiments 137-246.

253. Data sent over a network; the data is encrypted by a computer program according to any of embodiments 137-246.

254. Data sent over a network; the data is encrypted using a key; the decryption key can be derived or decrypted using an embedded at least one value or means for generating at least one value in a computer program according to any of embodiments 137-246.

255. Data sent over a network; the data is authenticated by a computer program according to any of embodiments 137-246.

256. A document into which at least one computer program according to any embodiments 137-246 is embedded.

257. A computer on which at least one computer program according to any of embodiments 137-246 is stored or executed.

258. A method of generating a one-time password, the method including the steps of any of embodiments 137-257.

259. A method of generating a one-time password in a device comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value, the method further comprising the step of processing said unique output to generate said one-time password.

260. A method according to embodiment 294 or 259 where the one-time password is derived from an embedded at least one value or means for generating at least one value.

261. A method according to embodiment 294 or 259 where the one-time password is derived from a master key; the master key is derived from an embedded at least one value or means for generating at least one value.

262. A method according to any of embodiments 294-261 where the one-time password is derived from a counter value; the counter is increased each time a one-time password is generated.

263. A method according to any of embodiments 294-262 where the one-time password is derived from a time stamp.

264. A device containing a one-time password generator constructed according to any of embodiments 294-263.

265. A computer network comprising a server and a plurality of clients, wherein each client is loaded with a copy of a first computer program, and wherein the server is loaded with a second computer program, each copy of the first computer program comprising:
a computer-executable program file fabricated from a source code, which is common to all copies of the first computer program;
at least one embedded value or means for generating at least one value, said value or said means being included in said computer-executable program file, said value being uniquely selected or uniquely generated for the computer-executable program file, whereby the computer-executable program file is capable of carrying out instructions provided by the common source code and of generating a unique output, which depends from said uniquely selected or uniquely generated value; the computer network being programmed to communicate said unique output from each of the clients to the server, so as to enable the second computer program to authenticate each copy of the first computer program based on said output.

266. A computer network according to embodiment 265, wherein each computer-executable program file is fabricated by a method according to any of embodiments 1-136.

267. A server for use in a computer network according to embodiment 265 or 266, the server being suited for communication with said plurality of clients via the computer network, said second computer program being adapted to authenticate each copy of said first computer program based on said unique output.

268. A method of generating a combined software component, comprising:
providing at least two non-combined software components, which are intended to be combined by an operating system at runtime or in a runtime environment;
combining said at least two non-combined software components into a pre-combined software component before runtime;
adding, to said pre-combined software component, functionality for performing operations that would have been performed by the operating system or the runtime environment, if the non-combined software components were combined at runtime, to thereby generate said combined software component.

269. A method according to embodiment 268 where at least one of the software components is a function implementations, a class, a library file, or a program file.

270. A method according to embodiment 268 or 269 where at least one of the software components is a Java class files, a Java .java files, or a function implementation is such files.

271. A method according to any of embodiments 268-270 where at least one of the software components is a .dll file or a function in such file.

272. A method according to embodiment 268, 269, or 271 where an .exe or a .dll file is derived from resulting software component.

273. A method according to any of embodiments 268-272 where at least one of the added means for handling tasks that otherwise would be handled by the runtime environment or operating system is means for handling memory allocation, stack operations, or errors.

274. A method according to any of embodiments 268-273 where the destination address of at least one jump instruction in the combined software component is read from a table.

275. A method according to any of embodiments 268-274 where at least one parameter to at least one instruction in the combined software component is read from a table.

276. A method according to embodiment 274 or 275 where at least a part of the table is downloaded from a server.

277. A method according to embodiment 276 where the at least a part of the table have a pre-defined value that is used until the at least a part of the table is downloaded from a server.

278. A method according to any of embodiments 274-277 where at least a part of the table is decrypted at runtime.

279. A method according to embodiment 278 where the decryption key is derived from the embedded at least one value or means for generating at least one value.

280. A method according to embodiment 278 where the decryption key is downloaded from a server.

281. A software component combined according to any of embodiments 268-280.

282. A computer-readable data medium comprising a software component according to embodiment 281.

283. A computer loaded with a software component according to embodiment 281.

284. A number of software components, which at runtime are linked together, at least one of the software components is a resulting software component or is derived from a resulting software component according to any of embodiments 268-280.

285. A method of fabricating a computer program according to any of embodiments 268-280 with an embedded at least one value or means for generating at least one value according to any of embodiments 1-136.

286. A computer program according to any of embodiments 268-280 with an embedded at least one value or means for generating at least one value according to any of embodiments 137-264.

287. A server communicating with a client computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

288. A server according to embodiment 287 with functionality that allows it to recreate at least one of
at least one of the at least one embedded values, and
at least a part of the embedded means for generating at least one value as is embedded in a Client Program.

289. A server according to embodiment 287 that can load from a database or file at least one of
at least one of the at least one embedded values, and
at least a part of the embedded means for generating at least one value
   as is embedded in a Client Program.

290. A server according to any of embodiments 287-289 that can load from a database or file the PRNG seed that was used to generate the string of pseudo-random bits that determined at least one of
at least one of the at least one embedded values, and
how to construct at least a part of the embedded means for generating at least one value
   when a Client Program file was fabricated.

291. A server according to embodiment 287 that can load and use a software module containing at least one of:
at least one of the at least one embedded values, and
at least a part of the embedded means for generating at least one value.

292. A server according to embodiment 291 where the loaded software module is stored in a file with program code that is linked with the server's program code at runtime.

293. A server according to embodiment 292 where the loaded software module is stored in a .dll file.

294: A server according to any of embodiments 287-293 where the recreated or loaded at least one value or means for generating at least one value is kept ready-to-use for a certain period of time after the session with the relevant program has ended such that the recreated or loaded at least one value or means for generating at least one value is ready for use in case of the given program connects to the server again within the given period of time.

295. A server according to any of embodiments 287-294 having a list of which rights are assigned to which types of Client Programs.

296. A server according to any of embodiments 287-295 having a list of which rights are assigned to which copies of the Client Program.

297. A server according to embodiment 295 or 296 where the assigned rights relate to which data types Client Program may read or write.

298. A server according to embodiment 295 or 296 where the assigned rights relate to which instances of data Client Program may read or write.

299. A server according to embodiment 295 or 296 where the assigned rights relates to who are allowed to execute Client Program.

300. A server according to embodiment 295 or 296 where the assigned rights relates to when a Client Program is allowed to be executed.

301. A server according to embodiment 295 or 296 where the assigned rights relates to when a Client Program is allowed to access which data.

302. A server according to any of embodiments 295-301 where a Client Program connects to the server to download information about its rights.

303. A server according to embodiment 302 where the downloaded information about the Client Programs rights is stored on disk by the Client Program.

304. A server according to any of embodiments 295-303 where a Client Program connects to the server to download cryptographic keys that can be used to encrypt, decrypt, or authenticate data.

305. A server according to embodiment 304 that refuses to provide keys to access types of data or copies of data that the Client Program is not allowed to access.

306. A server according to any of embodiments 295-305 where a log file is maintained with information about which Client Programs have been given which rights.

307. A server according to any of embodiments 295-306 where a log file is maintained with information about which Client Programs have been given which cryptographic keys.

308. A server according to any of embodiments 287-307 where key exchange protocol data communicated with a Client Program is encrypted or decrypted using a cryptographic key derived from an embedded at least one value or means for generating at least one value in the Client Program.

309. A server according to any of embodiments 287-307 where key exchange protocol data communicated with a Client Program is authenticated using a cryptographic key derived from an embedded at least one value or means for generating at least one value in the Client Program.

310. A server according to embodiment 308 or 309 where the key exchange protocol is the Diffie-Helman protocol.

311. A server according to any of embodiments 308-310 where the key exchange protocol is used to derive a symmetrical cryptographic key.

312. A server according to any of embodiments 287-311 where an asymmetric key is encrypted or decrypted using a cryptographic key derived from an embedded at least one value or means for generating at least one value in the Client Program.

313. A server according to any of embodiments 287-312 where an asymmetric key is authenticated using a cryptographic key derived from an embedded at least one value or means for generating at least one value in the Client Program.

314. A server according to embodiment 312 or 313 where the asymmetric key is a public RSA key or a private RSA key.

315. A server according to embodiment 312 or 313 where the asymmetric key is a public ECC key or a private ECC key.

316. A server according to any of embodiments 312-315 where the asymmetric key is used to derive a symmetrical cryptographic key.

317. A server according to embodiment 312 or 316 where the symmetrical key is used to encrypt or decrypt data.

318. A server according to any of embodiments 311, 316, and 317 where the symmetrical key is used to authenticate data.

319. A server according to any of embodiments 287-318 where Client Programs with functionality for sending e-mail, sending instant messages, or conducting phone calls connecting to the server are authenticated.

320. A server according to embodiment 319 where Client Programs with functionality for sending e-mail, sending instant messages, or conducting phone calls that cannot authenticate themselves are rejected.

321. A server according to embodiment 319 or 320 that adds special headers to e-mails, instant messages, or phone calls received from an authenticated Client Program.

322. A server according to any of embodiments 319-320 that signs e-mails, instant messages, or phone calls received from an authenticated Client Program.

323. A server according to any of embodiments 319-322 maintaining a list of black-listed Client Programs.

324. A server according to any of embodiments 287-323 where credit card information is encrypted or decrypted using a cryptographic key derived from an embedded at least one value or means for generating at least one value in the Client Program.

325. A server according to any of embodiments 287-324 where payment authorization data is encrypted or decrypted using a cryptographic key derived from an embedded at least one value or means for generating at least one value in the Client Program.

326. A server according to embodiment 325 where the payment authorization data comprises a credit card number.

327. A server according to embodiment 325 or 326 where the payment authorization data comprises a one-time password or one-time key.

328. A computer program communicating with a server according to any of embodiments 287-327.

329. A file encrypted by a server according to any of embodiments 287-327.

330. Data sent over a network; the data is encrypted by a server according to any of embodiments 287-327.

331. Data sent over a network; the data is authenticated by a server according to any of embodiments 287-327.

332. A computer-readable data medium comprising server software according to any of embodiments 287-327.

333. A computer program communicating with a server according to any of embodiments 287-327.

334. A device communicating with a server according to any of embodiments 287-327.

1. A method of fabricating computer-executable program files from a source code, the method comprising the step of embedding, in each of the fabricated computer-executable program files, at least one value or means for generating at least one value, said value being uniquely selected or generated for each of the fabricated computer-executable program files, whereby all of the fabricated computer-executable program files are capable of carrying out instructions defined by the source code, and whereby each individual computer-executable program file is capable of generating a unique output, which depends on said uniquely selected or uniquely generated value.

2. A method according to claim 1 wherein each user or group of users uses a different copy of the computer-executable program file.

3. A method according to claim 1 wherein the embedded means for generating at least one value depends on at least one embedded value.

4. A method according to claim 1 wherein the process of fabricating computer-executable program files from a source code is divided into at least two steps; a first step of converting source code into at least one intermediate file is performed once, and a later step of converting at least one intermediate file and optionally other files into a computer-executable program file is performed for each computer-executable program file.

5. A method according to claim 1 wherein at least a part of the source code is evaluated to determine if it meets one or more predefined criteria for being equipped with the embedded at least one value or means for generating at least one value.

6.-7. (canceled)

8. A method according to claim 1 wherein the embedded at least one value or means for generating at least one value is used to derive a cryptographic key.

9. (canceled)

10. A method according to claim 1 wherein the embedded at least one value or means for generating at least one value is used to authenticate a computer program.

11. A method according to claim 1 wherein the embedded at least one value or means for generating at least one value is used as a serial number or to derive a serial number that can be used to identify the copy of the computer program.

12. A method according to claim 1 wherein information about how a computer-executable program file is generated is stored such that the computer-executable program file can be reproduced or its functionality or part thereof can be reproduced or simulated.

13. A method of fabricating computer-executable program files according to claim 1 comprising the following steps:
1. choosing a PRNG seed,
2. generating a string of pseudo-random bits from the PRNG seed using a pseudo-random number generator,
3. using the string of pseudo-random bits to determine at least one embedded value or how to construct the embedded means for generating at least one value.

14. (canceled)

15. A method according to claim 13 wherein the PRNG seed is used to generate at least a part of the string of pseudo-random bits again, and wherein the string of bits is used to recreate at least one embedded value or the embedded means for generating at least one value.

16. (canceled)

17. A method according to claim 1 wherein the computer-executable program files are obfuscated and wherein obfuscation uses a random or pseudo-random input, so that the obfuscated computer-executable program file varies in accordance with the random or pseudo-random input.

18. (canceled)

19. A method according to claim 1 wherein at least a part of the computer-executable program file is stored in encrypted form and is decrypted at runtime.

20. A method according to claim 19 wherein the key to decrypt the encrypted at least a part of the computer-executable program code is downloaded from a server.

21. A method according to claim 1 wherein a computer-executable program file with at least one embedded value or embedded means for generating at least one value contains program code that can read profile data, the profile data comprises at least one of:
brand, type, version, or serial number of a hardware component,
brand, type, version, or serial number of a software component,
software or hardware configuration data,
network configuration data, and
identity of the user
wherein the profile data is used as input to the means for generating at least one value.

22. A method according to claim 1 wherein data is sent in encrypted or authenticated form between programs C and D; the encryption/decryption key or authentication key is derived from the embedded at least one value or means for generating at least one value in program C; the encryption/decryption key or authentication key is derived in program D from knowledge about the embedded at least one value or means for generating at least one value in C.

23. A method according to claim 1 wherein data is sent in encrypted or authenticated form between programs G and H where G and H both communicates securely with server I using cryptographic keys derived from G's and H's embedded at least one value or means for generating at least one value, and wherein the server I provides at least one cryptographic key to G and H to be used to encrypt/decrypt or authenticate at least a part of the data sent between G and H.

24.-31. (canceled)

32. A computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

33. (canceled)

34. A computer network comprising a server and a plurality of clients, wherein each client is loaded with a copy of a first computer program, and wherein the server is loaded with a second computer program, each copy of the first computer program comprising:
a computer-executable program file fabricated from a source code, which is common to all copies of the first computer program;
at least one embedded value or means for generating at least one value, said value or said means being included in said computer-executable program file, said value being uniquely selected or uniquely generated for the computer-executable program file, whereby the computer-executable program file is capable of carrying out instructions provided by the common source code and of generating a unique output, which depends from said uniquely selected or uniquely generated value; the computer network being programmed to communicate said unique output from each of the clients to the server, so as to enable the second computer program to authenticate each copy of the first computer program based on said output.

35. (canceled)

36. A server for use in a computer network according to claim 34, the server being suited for communication with said plurality of clients via the computer network, said second computer program being adapted to authenticate each copy of said first computer program based on said unique output.

37. A server communicating with a client computer program comprising a computer-executable program file fabricated from a source code, the computer program including, in said computer-executable program file, at least one embedded value or means for generating at least one value, said value being uniquely selected or uniquely generated for the computer-executable program file, whereby the computer-executable program file is capable of carrying out instructions provided by the source code and of generating a unique output, which depends from said uniquely selected or uniquely generated value.

38.-39. (canceled)
